(19) United States
(12) Patent Application Publication
(10) Pub. No.: US 2022/0351578 A1
(43) Pub. Date: Nov. 3, 2022

(54) ELECTRONIC GAMING DEVICE WITH MATRIX ELEMENTS AND USER-SELECTABLE ACTION ELEMENTS

(71) Applicant: Aristocrat Technologies, Inc., Las Vegas, NV (US)

(72) Inventor: Scott Delekta, Las Vegas, NV (US)

(73) Assignee: Aristocrat Technologies, Inc., Las Vegas, NV (US)

(21) Appl. No.: 17/491,243

(22) Filed: Sep. 30, 2021

Related U.S. Application Data
(60) Provisional application No. 63/181,620, filed on Apr. 29, 2021.

(51) Int. Cl. G07F 17/32; G07F 17/34

(52) U.S. Cl. CPC G07F 17/3265; G07F 17/34; G07F 17/3213

(57) ABSTRACT

Innovations in integrating a skill-based selection mechanism and a random number generator (“RNG”)-event-based mechanism in an electronic gaming device are described. For example, some of the innovations relate to integrating a skill-based selection mechanism and an RNG-event-based mechanism in an electronic gaming device that uses one or more sets of matrix elements and one or more sets of user-selectable action elements. User-selectable action elements are determined using RNG events. Matrix elements for a symbol matrix are also determined using RNG events. The action elements can be selectively applied, according to user input provided by a user, to change matrix elements (e.g., to “re-spin” one or more matrix elements, or to convert one or more matrix elements from one type to another type).

### RELATED APPLICATION INFORMATION

This application claims the benefit of U.S. Provisional Patent Application No. 63/181,620, filed Apr. 29, 2021, the disclosure of which is hereby incorporated by reference.

### FIELD

User interface (“UI”) features of electronic gaming devices are described herein, along with features of backend processing to implement the UI features. For example, an electronic gaming device uses a symbol matrix, with matrix elements determined at least some of the time using random events, as well as user-selectable action elements, which can be selectively applied by the user to change matrix elements.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or pay lines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of pay lines and/or the amount bet on each line. By varying the wager, the player may sometimes alter the frequency or number of winning combinations, frequency or number of secondary games, and/or the amount awarded.

Typical games use a random number generator (“RNG”) to randomly determine the outcome of each game. The game is designed to return a certain percentage of the amount wagered back to the player over the course of many plays or instances of the game, which is generally referred to as return to player (“RTP”). The RTP and randomness of the RNG ensure the fairness of the games and are highly regulated. Upon initiation of play, the RNG randomly determines a game outcome and symbols are then selected which correspond to that outcome.

EGMs depend on usability to enhance the user experience and extend player time on the EGMs. Although previous EGMs include various UI features, and backend operations associated with the UI features, that improve usability and enhance the user experience, there is room for further improvement to EGMs.

### SUMMARY

In summary, the detailed description presents innovations in integrating a skill-based selection mechanism and a random number generator (“RNG”)-event-based mechanism in an electronic gaming device. Some of the innovations relate to integrating a skill-based selection mechanism and an RNG-event-based mechanism in an electronic gaming device that uses one or more sets of matrix elements and one or more sets of user-selectable action elements. User-selectable action elements are determined using RNG events. Matrix elements in a symbol matrix are also determined using RNG events. According to user input, the action elements can be selectively applied to change matrix elements in the symbol matrix (e.g., by “re-spinning” one or more matrix elements of a particular type, or by converting one or more matrix elements from one type to another type). For example, the innovations described herein include, but are not limited to, innovations recited in the claims. This gameplay mechanic, which combines skill-based decisions for the user-selectable action elements with RNG-event-based aspects, increases user engagement and interaction with the electronic gaming device. These innovations also provide different tools for managing volatility and RTP in a computationally effective way when integrating a skill-based selection mechanism and RNG-event-based mechanism in an electronic gaming device.

The innovations can be implemented as part of a method, as part of an electronic gaming device such as an EGM or electronic gaming server configured to perform the method, or as part of non-transitory computer-readable media storing computer-executable instructions for causing one or more processors in a computer system to perform the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates, in block diagram form, an embodiment of a game processing architecture that implements a game processing pipeline for the play of a game in accordance with various embodiments described herein.

FIGS. 4a-4j are diagrams showing a UI of an electronic gaming device that uses one or more sets of matrix elements and one or more sets of user-selectable action elements.

FIGS. 5 and 6 are flowcharts showing example techniques, focusing on frontend operations and backend operations, respectively, for controlling the UI of an electronic gaming device that uses one or more sets of matrix elements and one or more sets of user-selectable action elements.

FIG. 7a-7e, 8a-8c, and 9a-9f are diagrams illustrating different features of example implementations of an electronic gaming device that uses one or more sets of matrix elements and one or more sets of user-selectable action elements.

### DETAILED DESCRIPTION

The detailed description presents innovations in integrating a skill-based selection mechanism and an RNG-event-based mechanism in an electronic gaming device. For example, some of the innovations relate to integrating a skill-based selection mechanism and an RNG-event-based mechanism in an electronic gaming device that uses one or more sets of matrix elements and one or more sets of user-selectable action elements. User-selectable action elements are determined using RNG events. Matrix elements for a symbol matrix are also determined using RNG events. The action elements can be selectively applied, according to user input provided by a user, to change matrix elements (e.g., to “re-spin” one or more matrix elements, or to convert one or more matrix elements from one type to another type). By combining skill-based decisions for the action elements with RNG-event-based aspects, this gameplay mechanic increases user engagement and interaction with the electronic gaming device. In particular, by providing a way to change matrix elements, the gameplay mechanic provides the player some control over an outcome. These innovations also provide different tools for managing volatility and RTP in a computationally effective way when integrating a skill-based selection mechanism and an RNG-event-based mechanism in an electronic gaming device, while improving usability of the electronic gaming device and enhancing the user experience. For additional details about technical advantages, see section V.F.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. Example Electronic Gaming Servers and Electronic Gaming Machines (“EGMs”).

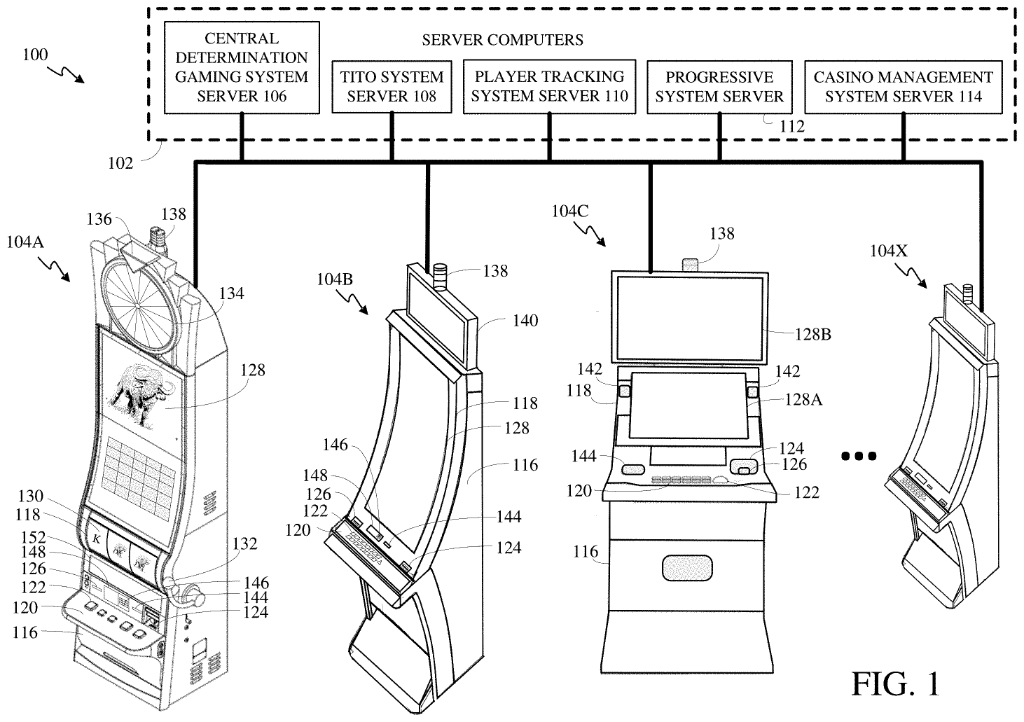

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (“RF”) (e.g., wireless fidelity (WiFi®) and Bluetooth®), cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (“TITO”) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (TITO) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some embodiments, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

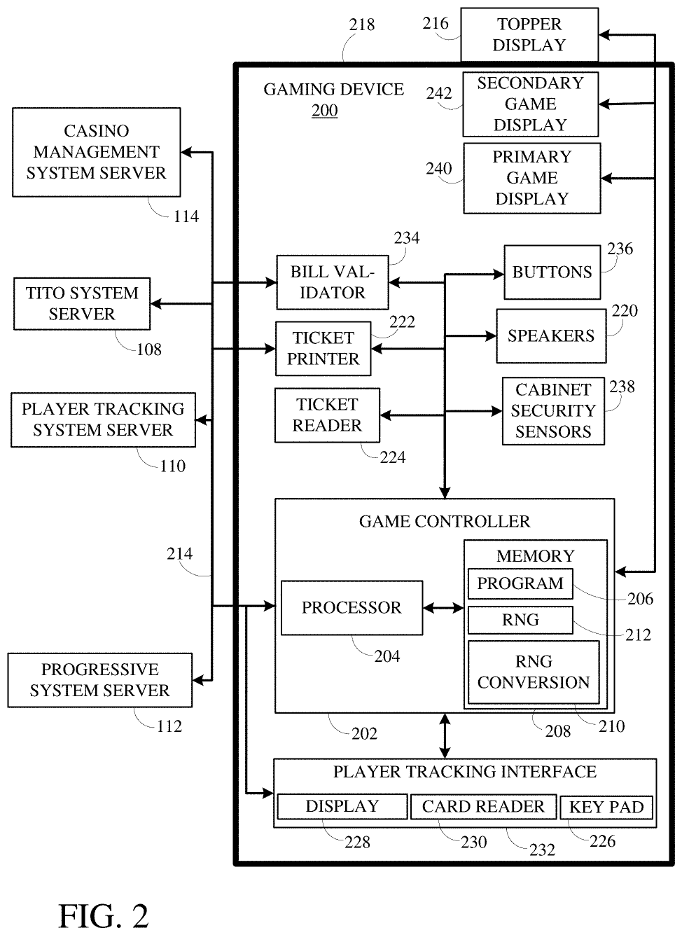

Many or all the above described components can be controlled by circuitry (e.g., a game controller) housed inside the main cabinet 116 of the gaming device 104A, the details of which are shown in FIG. 2.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of pay lines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. As shown in FIG. 2, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on a chip (SoC) that combines and integrates one or more general-purpose processors and/or one or more specialized processors. Although FIG. 2 illustrates that game controller 202 includes a single processor 204, game controller 202 is not limited to this representation and instead can include multiple processors 204 (e.g., two or more processors).

FIG. 2 illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2 illustrates that game controller 202 includes a single memory 208, game controller 202 could include multiple memories 208 for storing program instructions and/or data.

Memory 208 can store one or more game programs 206 that provide program instructions and/or data for carrying out various embodiments (e.g., game mechanics) described herein. Stated another way, game program 206 represents an executable program stored in any portion or component of memory 208. In one or more embodiments, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchange with one or more remote gaming devices, such as a central determination gaming system server 106 (not shown in FIG. 2 but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2 illustrates that gaming device 200 includes an RNG 212 that utilizes hardware and/or software to generate RNG outcomes that lack any pattern. The RNG operations are often specialized and non-generic in order to comply with regulatory and gaming requirements. For example, in a reel game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more embodiments, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2 illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts. As explained below, a conversion engine (such as the RNG conversion 210) can also account for non-RNG outcomes, which are based on user input, to adapt or select game features.

FIG. 2 also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gamine device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). In addition, the player may select options for a skill-based mechanism. The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Although FIGS. 1 and 2 illustrate specific embodiments of a gaming device (e.g., gaming devices 104A-104X and 200), the disclosure is not limited to those embodiments shown in FIGS. 1 and 2. For example, not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Additionally, or alternatively, gaming devices 104A-104X and 200 can include credit transceivers that wirelessly communicate (e.g., Bluetooth or other near-field communication technology) with one or more mobile devices to perform credit transactions. As an example, bill validator 234 could contain or be coupled to the credit transceiver that output credits from and/or load credits onto the gaming device 104A by communicating with a player's smartphone (e.g., a digital wallet interface). Gaming devices 104A-104X and 200 may also include other processors that are not separately shown. Using FIG. 2 as an example, gaming device 200 could include display controllers (not shown in FIG. 2) configured to receive video input signals or instructions to display images on game displays 240 and 242. Alternatively, such display controllers may be integrated into the game controller 202. The use and discussion of FIGS. 1 and 2 are examples to facilitate ease of description and explanation.

Those of skill in the art will appreciate that embodiments of the present disclosure could be implemented with more or fewer elements than are depicted in FIG. 2. The pictured example embodiments of a gaming device 200, as well as example gaming devices 104A-C, are merely a few examples from a wide range of possible gaming device designs on which embodiments of the present disclosure may be implemented. Depending on implementation and the type of processing desired, components of the gaming device 200 can be added, omitted, split into multiple components, combined with other components, and/or replaced with like components. In alternative embodiments, gaming devices with different components and/or other configurations of components perform one or more of the described techniques. Specific embodiments of gaming devices typically use a variation or supplemented version of the gaming device 200. The relationships shown between components within the gaming device 200 indicate general flows of information in the gaming device 200; other relationships are not shown for the sake of simplicity. In general, the game controller 202 can be implemented by software executable on a CPU, by software controlling special-purpose hardware, or by special-purpose hardware (e.g., in an ASIC).

### II. Example Game Processing Architectures.

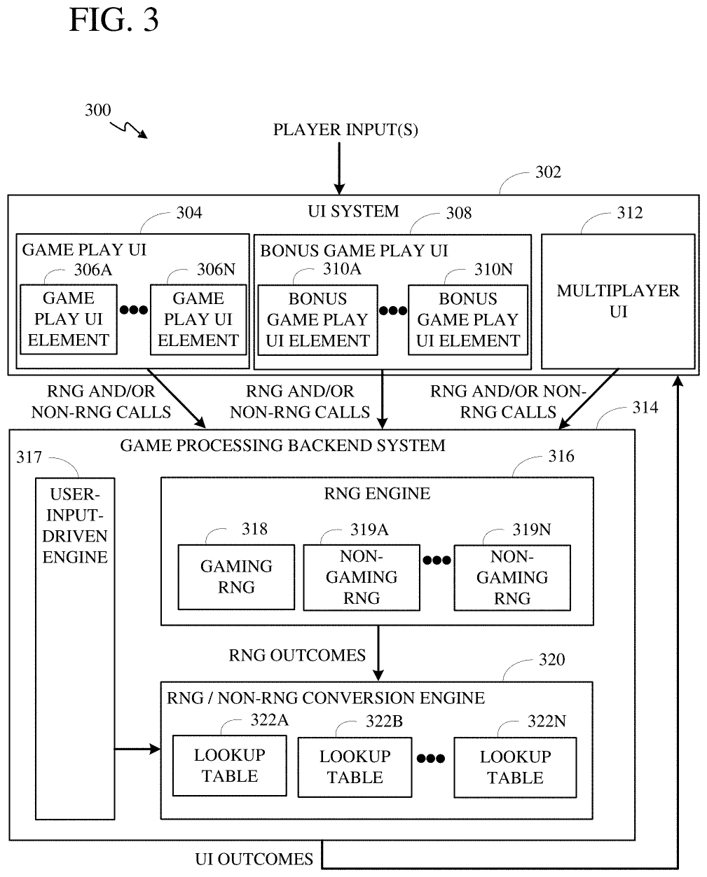

FIG. 3 illustrates, in block diagram form, an embodiment of a game processing architecture 300 that implements a game processing pipeline for the play of a game in accordance with various embodiments described herein. As shown in FIG. 3, the gaming processing pipeline starts with having a UI system 302 receive one or more player inputs for the game instance. Based on the player input(s), the UI system 302 generates and sends one or more RNG calls and/or one or more non-RNG calls to a game processing backend system 314. Game processing backend system 314 then processes the RNG calls with RNG engine 316 to generate one or more RNG outcomes. Game processing backend system 314 processes the non-RNG calls with user-input-driven engine 317 to generate one or more non-RNG outcomes. For example, a non-RNG call can include information about a stop position of a reel, card position, or other UI feature selected by a user for a skill-based mechanism or, more generally, include other information about user input for a skill-based mechanism. The RNG outcomes and non-RNG outcomes are then sent to the RNG/non-RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. For example, the UI elements can include mechanical and/or graphical elements for one or more skill-based mechanisms and one or more RNG-event-based mechanisms. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more embodiments, at least some of the game play UI element 306A-306N are similar to the bonus game play UI elements 310A-310N. In other embodiments, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls and/or non-RNG calls to a game processing backend system 314. As an example, the UI system 302 could use one or more application programming interfaces (“APIs”) to generate the RNG calls. To process the RNG calls, the RNG engine 316 could utilize gaming RNG 318 and/or non-gaming RNGs 319A-319N. Gaming RNG 318 corresponds to RNG 212 shown in FIG. 2. As previously discussed with reference to FIG. 2, gaming RNG 318 often performs specialized and non-generic operations that comply with regulatory and/or game requirements. For example, because of regulation requirements, gaming RNG 318 could be a cryptographic random or pseudorandom number generator (“PRNG”) (e.g., Fortuna PRNG) that securely produces random numbers for one or more game features. To generate random numbers, gaming RNG 318 could collect random data from various sources of entropy, such as from an operating system (“OS”). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for such as generating random messages that appear on the gaming device.

To process non-RNG calls, the user-input-driven engine 317 maps inputs received for the non-RNG calls to non-RNG outcomes, which are provided to the conversion engine 320. For example, the user-input-driven engine 317 maps information about a stop position for a reel, card position, or other UI element selected by a user for a skill-based mechanism to an outcome for that skill-based mechanism in the context of an instance of a base game or bonus game.

The RNG/non-RNG conversion engine 320 processes each RNG outcome from RNG engine 316 and each non-RNG outcome from the user-input-driven engine 317, and converts the outcomes to a UI outcome that is fed back to the UI system 302. With reference to FIG. 2, conversion engine 320 corresponds to conversion engine 210 used for game play. As previously described, conversion engine 320 translates the RNG outcome from the RNG 212 to a game outcome presented to a player. The conversion engine 320 can use a non-RNG outcome to select a game outcome presented to a player (such as a selection for a skill-based mechanism). In some example implementations, the conversion engine 320 can, based on a non-RNG outcome, adapt how a game outcome is selected using an RNG outcome (e.g., adjusting reel strips, dynamic symbol resolution, or lookup tables to balance overall RTP in view of the non-RNG outcome). RNG/non-RNG conversion engine 320 utilizes one or more lookup tables 322A-322N to regulate a prize payout amount for each RNG outcome and how often the gaming device pays out the derived prize payout amounts. In one example, the conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel, where the reel is an RNG-event-based reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

The example game processing architecture 300 shown in FIG. 3 can be used to process game play instructions and generate outcomes as described in later sections.

### III. Example Reel Games and Outcome Determination Approaches.

Electronic gaming devices can incorporate the innovations described herein into various types of reel games or other games. A reel game can be a base reel game or bonus reel game. A base, or primary, reel game includes play that involves spinning reels. A bonus, or secondary, reel game/feature can add the possibility of winning a relatively large payout. A bonus reel game/feature may require an additional wager, but typically does not. A single play of a reel game can constitute a single complete game or wager, e.g., a single spin of the reels or a series of spins which culminate in a final aggregate outcome. Depending on implementation, in addition to a base reel game, an electronic gaming device can conduct a bonus reel game and/or a gateway wheel game. A reel game uses spinning reels and one or more reel areas (game windows) on a display screen.

In examples described herein, the set of reels of an electronic gaming device include one or more RNG-event-based reels. The RNG-event-based reel(s) have associated reel strips. The reel strip for an RNG-event-based reel includes symbol instances.

For a reel game, a reel area encloses viewable portions of a set of reels associated with the reel area. For each of the reels, the viewable portion of the reel includes one or more positions for instances of symbols. Thus, the reel area is a matrix of instances of symbols on a display screen, and may be highlighted graphically to emphasize reels and symbol instances within the reel area. The number of reels and dimensions of the reel area depend on implementation. In some configurations, a reel area has m reels and can enclose different counts of symbol instances for different reels. For example, a reel area encloses 4 symbol instances for a first reel, 6 symbol instances for each of a second reel, third reel, and fourth reel, and 4 symbol instances for a fifth reel. Such a configuration can be described as a 4-6-6-6-4 configuration. Or, as another example, a reel area has an m×n configuration, with m reels and with n symbol instances visible per reel. For example, for a base reel game, a reel area can have a 5×3 configuration—five reels per window, with three symbol instances showing in the window for each of the reels. More generally, the reel area spans m reels in a first dimension and spans n symbol instances in a second dimension orthogonal to the first dimension, where the value of m can be 4, 5, 6, 7, 8, or some other number of reels, and the value of n can be 2, 3, 4, 5, 6, or some other number of symbol instances, which can be the same or different for different reels. Typically, the m reels are arranged horizontally in the reel area from left-to-right, with the m reels spinning vertically and the reel area showing symbol instances of each of the respective reels. Alternatively, the m reels are arranged vertically in the reel area from top-to-bottom, with the m reels spinning horizontally and the reel area showing symbol instances of each of the respective reels. Alternatively, a reel area can have another configuration, such as one in which the reel area encloses a single symbol instance per independent reel. For example, symbol instances can be arranged in a p×q configuration, with p indicating a count of symbol instances horizontally across the p×q configuration, with q indicating a count of symbol instances vertically across the p×q configuration, and with each of the symbol instances being associated with a different, independent reel.

For each of the reels, a reel strip includes x positions along a one-dimensional strip of symbol instances, where x depends on implementation. For example, x is 30, 80, 100, 200, or some other number of positions. The value of x can be the same or different for different reels (thus, different reels can have different numbers of positions). Each reel can have a data structure (e.g., array, linked list, table) that tracks the symbol instances at the respective positions of the reel strip for the reel. In some implementations, the configuration of the symbol instances at the positions of the reel strips for the reels of a reel game is fixed after the reel game boots, although limited reconfiguration operations may be permitted. In other implementations, the configuration of the symbol instances at the positions of the reel strips for the reels of a reel game can change dynamically after the reel game boots (e.g., depending on bet amount or some other factor). Different sets of reels can be used for a base reel game, special mode of a base reel game, and bonus reel game or other supplemental feature. For example, for a special mode of a base reel game, more “valuable” symbols, such as a wild symbol or scatter symbol, can be added to the reels of a base reel game or swapped in for other symbols on the reels.

The symbol set for reels has various types of symbols, including one or more target symbols and other symbols. The symbols can be static or animated. Depending on implementation, the symbol set for the reels includes one or more target symbol types, at least one jackpot symbol type, a wild symbol type, some number of picture symbol types, some number of minor/low symbol types, and a scatter symbol type (which triggers bonuses). Alternatively, the symbol set for the reels can include other and/or additional symbols. In general, for a given type of symbol, one or more instances of the symbol can appear in a reel strip, but games can have different constraints on symbol placement. Depending on context, the term “symbol” can indicate a symbol type or a symbol instance. In general, an instance of wild symbol can substitute for any other symbol (except, in most implementations, a scatter symbol or jackpot symbol) when determining win conditions along pay lines. In general, an instance of a scatter symbol can contribute to a win condition even if it is not on the same pay line as another scatter symbol. In some implementations, a win condition depends on a count of instances of a scatter symbol that occur anywhere within a reel area, regardless of where they land within the reel area. The symbol set can be the same or different between a base reel game and bonus reel game (or other supplemental feature). Some types of symbols are dimmed out (not active) at times (e.g., symbols other than target symbols are dimmed out during a feature).

As in a reel game with physical reels, the reels of a reel game on a display screen “spin” graphically through a reel area on the display screen when a player actuates a “spin” or “play” button, which acts as a “handle pull” event. For RNG-event-based reels, a backend system randomly selects symbol positions of reel strips at which to stop the reel strips for the respective reels, and the respective reels stop at the selected symbol positions of the reel strips, with some number of symbol instances visible in the game window for each of the reels. For example, for a given RNG-event-based reel, the backend system generates a random number and determines a symbol position at which to stop the reel strip of the reel using the random number (e.g., with a lookup table). The backend system generates different random numbers for the respective RNG-event-based reels that are spun. In this way, the backend system can determine which symbol instances of the respective RNG-event-based reels are visible in the game window (reel area) on the display screen.

In other scenarios, symbol instances visible in a reel area can be converted from one type of symbol instance to another type of symbol instance, e.g., when a user-selectable action element is applied. For a user-selectable action element, whether and when to apply the action element depends on user input. For example, a user actuates a button (e.g., physical button, touchscreen button, or other virtual button) and, based on the button actuation, the order to play an action element is determined.

In general, a display screen (or simply “display” or “screen”) for a reel game is an area that conveys information to a viewer. The information may be dynamic, in which case, the display screen may use LCD technology, LED technology, cathode ray tube (CRT) technology, or some other display technology. A main display screen (also called a primary game screen or main display) can be a display screen or an area of a display screen used to display game information related to a base reel game, such as a video representation of one or more spinning reels. A secondary display screen (also called a secondary game screen or bonus display) can be a display screen or an area of a display screen used to display secondary game information, such as animations and other graphics associated with a bonus reel game. A credit display can display a player's current number of credits, cash, account balance, or the equivalent. A bet display can display a player's amount wagered. The credit display and/or bet display may be standalone displays, independent of the main display and bonus display. Alternatively, the credit display and/or bet display can be incorporated into the main display or bonus display. Any of the display screens can be implemented as a touchscreen, with an associated touchscreen controller. In this case, such display screens may be operated as input devices in addition to presenting information, to provide input game play decisions (e.g., actions on and selection of game presentation objects).

An electronic gaming device may award a special mode for a base reel game, a bonus reel game, or a supplemental feature to a player. A special mode, bonus reel game, or supplemental feature may enhance the electronic gaming device and the experience of players by adding elements of excitement and chance. The special mode, bonus reel game, or supplemental feature can utilize a different set of reels, display screens, controls, symbols, etc. than the base reel game in normal operation. Alternatively, the special mode, bonus reel game, or supplemental feature can reuse or reconfigure at least some of the reels, display screens, symbols, etc. of a base reel game. The special mode, bonus reel game, or supplemental feature can be started in response to satisfaction of a trigger condition. For example, a special mode, bonus reel game, or supplemental feature can be triggered upon the occurrence of some defined combination of symbol instances or threshold count of target symbol instances in one or more sets of reels. Alternatively, the special mode, bonus reel game, or supplemental feature can be triggered in some other way (e.g., randomly).

In general, a backend system can determine various outcomes and perform operations for various types of base reel games, special modes, and supplemental features. A UI system can then output indications of those outcomes and perform operations for various types of base reel games, special modes, and supplemental features. For example, for various types of events, the backend system uses an RNG (which can be a cryptographic RNG or PRNG) to generate a random number and maps the random number to an outcome using a lookup table. This series of operations is generally referred to as an RNG event. FIG. 3 shows examples of lookup tables 322A-322N, which are also called weighted tables. In general, a lookup table can be implemented as any data structure that assigns probabilities to different options, in order for one of the different options to be selected using a random number. Different options are represented in different entries of a lookup table. The probabilities for different options can be reflected in threshold values (e.g., for a random number RND, generated by an RNG, in the range 0<RND<=100, with four options, 0<RND<=40 for option 1, 40<RND<=70 for option 2, 70<RND<=90 for option 3, and 90<RND<=100 for option 4). The threshold values can represent percentages or, more generally, sub-ranges within the range for a random number. In some implementations, the threshold values for a lookup table are represented as count values (weights) for the respective entries of the lookup table. For example, the following table shows count values for the four options described above:

TABLE 1
Example Lookup Table

| count value | entry |
|---|---|
| 40 | <value a1, value a2, . . . > |
| 30 | <value b1, value b2, . . . > |
| 20 | <value c1, value c2, . . . > |
| 10 | <value d1, value d2, . . . > |

The sum total of the count values (weights) indicates the range of the options. The backend system can use a random number, generated between 1 and the sum total of the count values, to select one of the entries in the lookup table by comparing the random number to successive running totals. In the example shown in Table 1, if the random number is 40 or less, the first entry is selected. Otherwise, if the random number is between 41 and 70, the second entry is selected. Otherwise, if the random number is between 71 and 90, the third entry is selected. Otherwise, the last entry is selected. The threshold values for a lookup table can be fixed and predetermined. Or, the threshold values for a lookup table can vary dynamically (e.g., depending on bet amount). Or, a lookup table can be dynamically selected (e.g., depending on bet amount, depending on another factor) from among multiple available lookup tables. Different parameters or choices during game play can use different lookup tables. Or, different combinations of parameters or choices can be combined in entries of a given lookup table.

In general, after RNG-event-based reels have landed (stopped) in a reel area, any win conditions can be detected and any win amounts can be awarded to the player (e.g., credited to the player's credit balance). In some examples described herein, however, matrix elements in RNG-event-based reels can be changed according to user-selectable action elements before win conditions are detected.

In some examples, win conditions depend on a count of target symbol instances in a reel area. In other examples, win conditions are defined as combinations of symbol instances along pay lines (also called win lines) across at least a portion of a reel area on a display screen. Typically, a pay line is traversed from one side of the reel area to the opposite side of the reel area (e.g., left to right), using one symbol instance per column along the pay line as part of possible combinations of symbol instances. For a round of play, when a certain combination of symbol instances appears along a pay line, a win amount corresponding to that combination of symbol instances and that pay line is awarded. Win amounts can vary according to the combination of symbol instances and according to the particular pay line along which the combination of symbol instances appears. Win amounts are typically determined according to a pay table, where the pay table comprehends the various combinations of symbol instances and pay lines that may occur (examples of win conditions). The win amount for a round of play may be a fraction of an amount wagered for that round of play for certain win conditions. For other win conditions, the win amount may be much larger than the amount wagered. The number of pay lines and base credit cost to play depends on implementation. There can be 2×, 3×, 4×, and 5× bet multipliers. Multipliers can also appear as symbols in reels. Alternatively, there could be higher bet multipliers (e.g., up to 8×), different credit options, and/or a different number of pay lines.

Depending on implementation, symbol instances along a pay line can be counted in different ways. For example, when evaluating a win condition along a pay line, symbol instances along the pay line in any column can be counted, even if the columns are not adjacent. Alternatively, when evaluating a win condition along a pay line, only symbol instances along the pay line in adjacent columns are counted. For a given pay line, only the highest-paying combination of symbol instances is awarded. Alternatively, for a given pay line, all possible combinations of symbol instances are awarded, in the aggregate. A given symbol instance (e.g., wild symbol) is counted only towards its highest-paying combination in a given pay line. Alternatively, a given symbol instance can be counted towards multiple combinations in a given pay line.

Instead of evaluating win conditions on explicitly designated pay lines across columns in a reel area, an award can be determined according to a “ways” approach, which is also referred to herein as “all-ways evaluation” or simply “ways evaluation.” For all-ways evaluation, each possible path through designated (active) symbol display position(s) of the respective columns provides a way to win. A path is traversed from one side of the reel area to the opposite side of the reel area (e.g., left to right), using one symbol instance per column along the path. For one symbol instance per column in a combination, any symbol instance displayed at an active symbol display position for a given column in the reel area can be used to form a symbol instance combination with any symbol instance displayed at an active display position of each of the other columns. As a result, the total number of ways to win is determined by multiplying the number of active display position(s) of each column. For example, for five columns each showing three symbol instances at active display positions in a reel area, there are 3⁵=243 ways to win for all-ways evaluation. As another example, for five columns, with the first and last columns each showing four symbol instances and the other reels each showing ten symbol instances at active display positions in the reel area, there are 4×10×10×10×4=16000 ways to win for all-ways evaluation.

For all-ways evaluation, the designated (active) symbol display positions for the respective columns can be pre-defined and static. For example, the designated (active) symbol display positions for each column can be all of the symbol display positions enclosed in a reel area for the column. Or, the designated (active) symbol display positions for the respective columns can change, e.g., depending on a bet amount. In some implementations, an individual column can be selected to have all symbol display positions active or only a single symbol display position active, e.g., for different bet amounts. That is, the symbol instance displayed in any symbol display position can be used for a selected column. For example, depending on the bet amount, all symbol display positions per column can be active for one column, two columns, three columns, four columns, or five columns. If all symbol display positions are not active for a column, then only one symbol display position is active for that column for all-ways evaluation. For example, for five columns each showing three symbol instances in a reel area, if three columns are selected, there are 3×3×3×1×1=27 ways to win for all-ways evaluation. For such all-ways evaluation, each possible path through the designated (active) symbol display position(s) of the respective columns provides a way to win. The total number of ways to win is determined by multiplying the number of active symbol display position(s) of each column, where the active symbol display position(s) for a column are all symbol display positions in the reel area for a selected column but only the designated (e.g., center) symbol display position in the reel area for a non-selected column.

In some implementations, for all-ways evaluation using a set of reels, a backend system determines which symbol display positions of the reel area are active for the columns, respectively. For example, the backend system determines which symbol display positions of the reel area are active for the columns, respectively, depending on the bet amount. Alternatively, the symbol display positions of the reel area that are active for the columns, respectively, can be pre-defined and static. In any case, for all of the possible paths through the active symbol display positions of the reel area, the backend system evaluates combinations of instances of symbols along the possible paths for one or more win conditions. Each of the possible paths uses one of the instances of symbols per column and crosses the reel area from one side of the reel area to an opposite side of the reel area (e.g., left to right).

### IV. Example Implementations in an Electronic Gaming Device.

This section describes example implementations in an electronic gaming device, in which the innovations described herein can be implemented. The example implementations are presented to provide examples of context for the innovations. The innovations described herein can be used in other implementations. For example, the innovations described herein can be used in implementations of an electronic gaming device with different hardware features and/or different gameplay mechanics. Also, although the innovations described herein can be used in combination, the innovations described herein can also be used separately.

In some example implementations, a process uses one or more sets of matrix elements and one or more sets of user-selectable action elements. The process can be a base reel game or other reel game. Alternatively, the process can be a bingo game, keno game, or other type of game.

In some example implementations, a player can choose a bet denomination (e.g., one cent, two cents, five cents) or use a default bet denomination for a base reel game. The player can also choose a bet amount (e.g., different amounts of credits) or use a default bet amount. The bet amount affects the number of columns that are selected for all-ways evaluation. The player can also choose a bet multiplier (e.g., 1×, 2×, 3×, 4×, 5×) or use a default bet multiplier (e.g., 1×). Alternatively, other bet settings, evaluation approaches, etc. can be used.

The player initiates a spin for the base reel game (e.g., pushing a spin button). The spin uses the bet denomination, bet amount, and bet multiplier in effect (either default or selected by the player), assuming credits are sufficient in a credit meter. The credit meter decreases by the bet size. Various aspects of gameplay can depend on the bet denomination, bet amount, and bet multiplier in effect, as described below.

For the spin of the base reel game, an outcome is determined. For example, win conditions are evaluated using scatter pays evaluation, with one or more threshold counts for identical symbols. Or, the example implementations can use all-ways evaluation, with the number of selected (active) columns depending on bet amount, or pay line evaluation. In any case, after the outcome evaluation for a spin of the base reel game, any credits from winning combinations of symbol instances are shown in a win meter and added to a credit meter.

When a supplemental feature, special mode, or free games feature for the base reel game is triggered, the spin of the base reel game proceeds in the supplemental feature, special mode, or free games feature for the base reel game. Various aspects of the base reel game can be adjusted. After outcome evaluation, any credits from winning combinations of symbol instances are shown in a win meter and added to a credit meter.

V. Example Electronic Gaming Devices that Use Set(s) of Matrix Elements and Set(s) of User-Selectable Action Elements.

This section describes innovations in UI features of electronic gaming devices, as well as innovations in features of backend processing to implement the UI features. Some of the innovations relate to controlling the UI of an electronic gaming device that uses one or more sets of matrix elements and one or more sets of user-selectable action elements. For example, for an instance of a process, user-selectable action elements and matrix elements in a symbol matrix are determined using RNG events. After the matrix elements have landed, the matrix elements can be changed according to the action elements. Specifically, the action elements can be selectively applied, according to user input provided by a user, to change matrix elements (e.g., to “re-spin” one or more matrix elements, or to convert one or more matrix elements from one type to another type). This gameplay mechanic increases user engagement and interaction with the electronic gaming device. In particular, by providing a way to change matrix elements, the gameplay mechanic provides the player some control over an outcome. The innovations described herein also provide ways to satisfy gaming regulations and RTP requirements while using RNG events (e.g., for slot reels) in combination with user-selectable events (e.g., for a card playing/decision mechanic) that affect RTP.

For example, a display screen of an electronic gaming device shows a symbol matrix that contains matrix elements for a base reel game. The matrix elements can be standard symbol instances (e.g., instances of high-value symbol types, low-value symbol types, wild symbol types, scatter symbol types, etc.). For a spin of the base reel game, one or more user-selectable action elements are determined using RNG events. For example, a player is dealt multiple cards, which are displayed adjacent the symbol matrix. For the spin of the base reel game, matrix elements are determined using RNG events and land in the symbol matrix. The player can choose to apply, or not apply, the action element(s) in an order specified by the player (e.g., to “play” cards in any order). When a user-selectable action element is applied, the action element can affect one or more matrix elements that landed in the symbol matrix (e.g., to transform one or more symbol instances of a particular symbol type from one shape/color/etc. to a different shape/color/etc.; or, to re-spin one or more symbol instances of a particular symbol type, removing the symbol instance(s) of the particular symbol type and performing a single re-spin per symbol instance to replace that symbol instance). An outcome for the spin is determined based on the matrix elements in the symbol matrix after the action element(s) have been applied.

In a typical architecture, an RNG engine determines stop positions for all spinning reels, which are RNG-event-based reels. The processing pipeline for such an architecture can be modified to (1) receive a notification indicating a stop position for an RNG-event-based reel, or otherwise indicating a new matrix element, according to a user-selectable action element, and (2) cause the change indicated by the action element. Typically, a backend system is local to an electronic gaming device or connected by a fast network connection to the electronic gaming device, such that delay is not problematic.

Innovative features described herein include, but are not limited to, the features reflected in the claims. More generally, the innovative features described herein include, but are not limited to, combining a random-based game (e.g., a game that uses random events to determine matrix elements such as symbol instances for slot reels and to determine user-selectable action elements such as cards) with a skill-based decision mechanic to modify results of the random-based game (e.g., to play one or more of the action elements to modify the matrix elements), where the skill-based decision mechanic affects RTP. The action elements (e.g., cards) can be associated with operations that follow rules and/or use additional random events to modify matrix elements. In particular, one type of action element can be applied to transform one or more matrix elements of a particular type (shape, color, etc.) to a different type. Another type of action element can be applied to remove one or more matrix elements of a particular type (shape, color, etc.) and replace those matrix element(s) using additional random events (re-spin). Still other types of action elements can be applied to cause other transformations, as described below.

A. Example UI for Electronic Gaming Device with Matrix Elements and User-Selectable Action Elements.

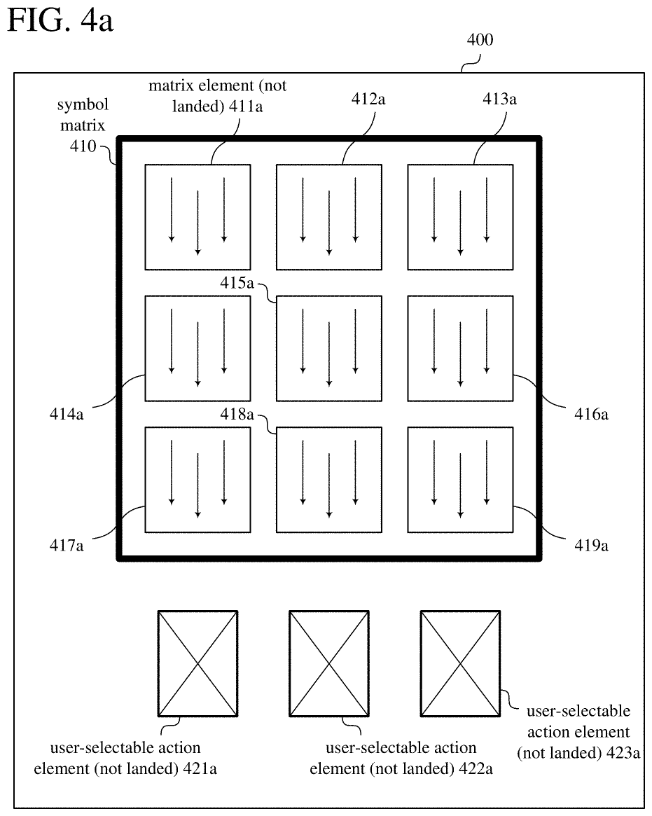

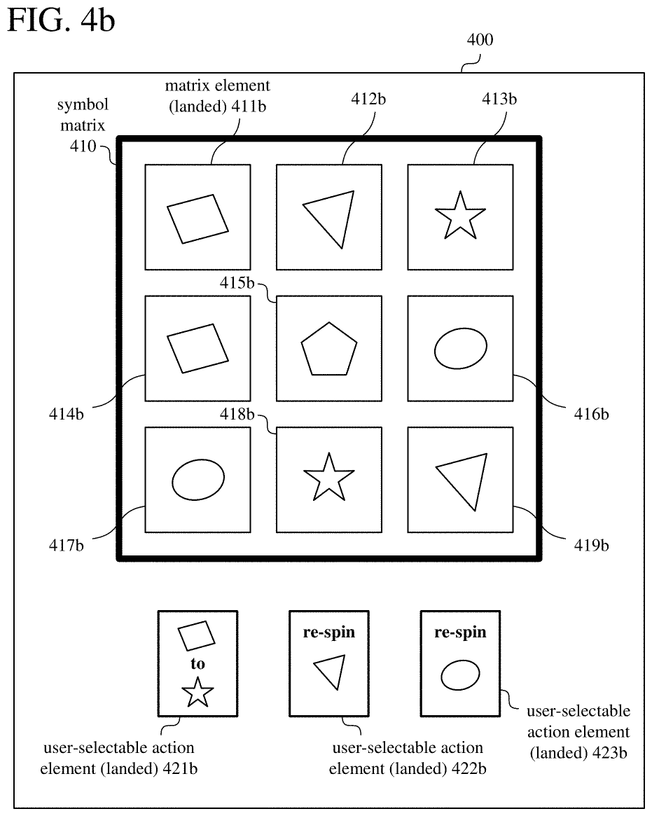

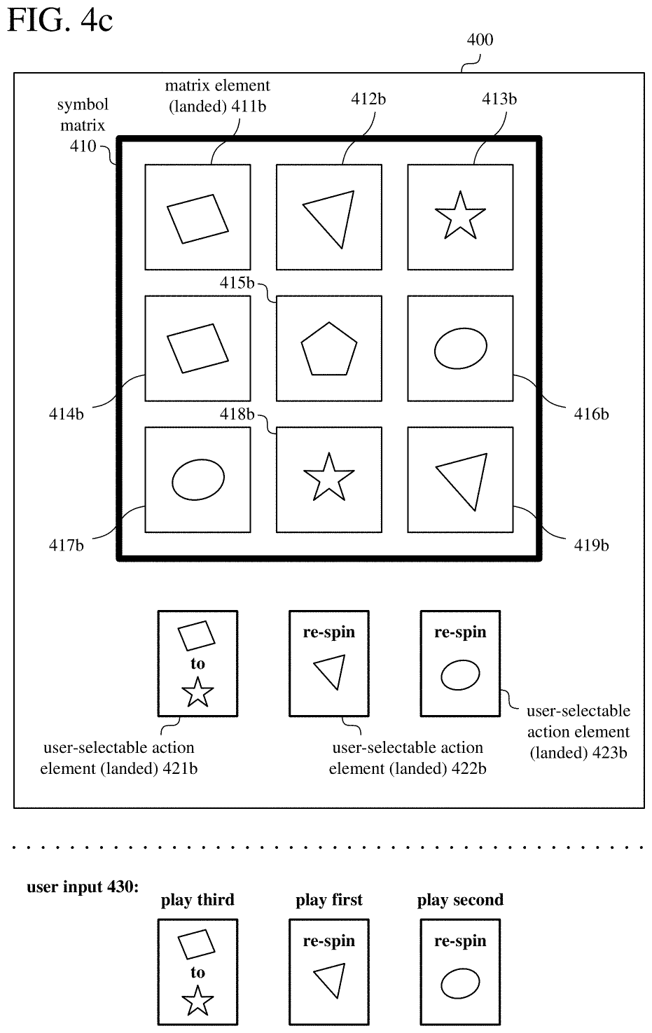

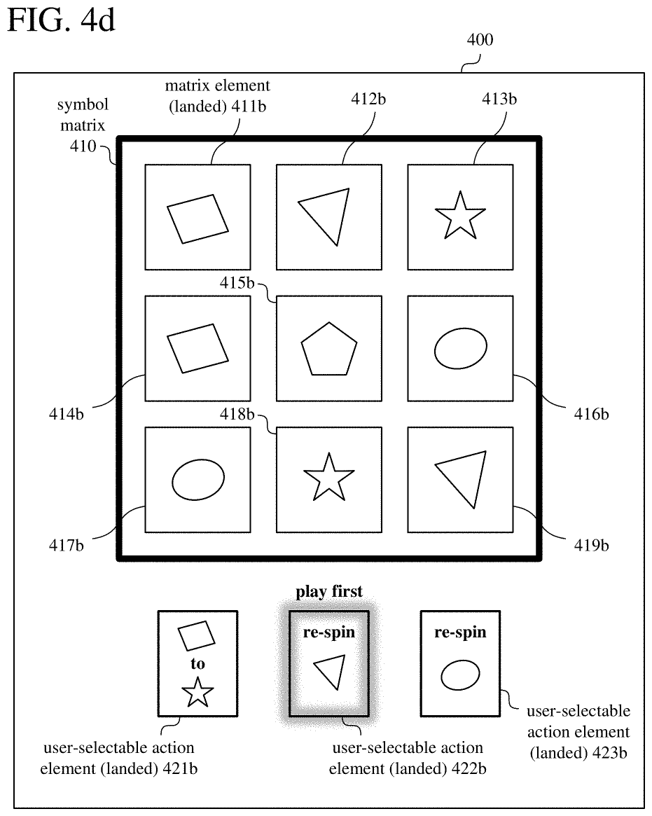

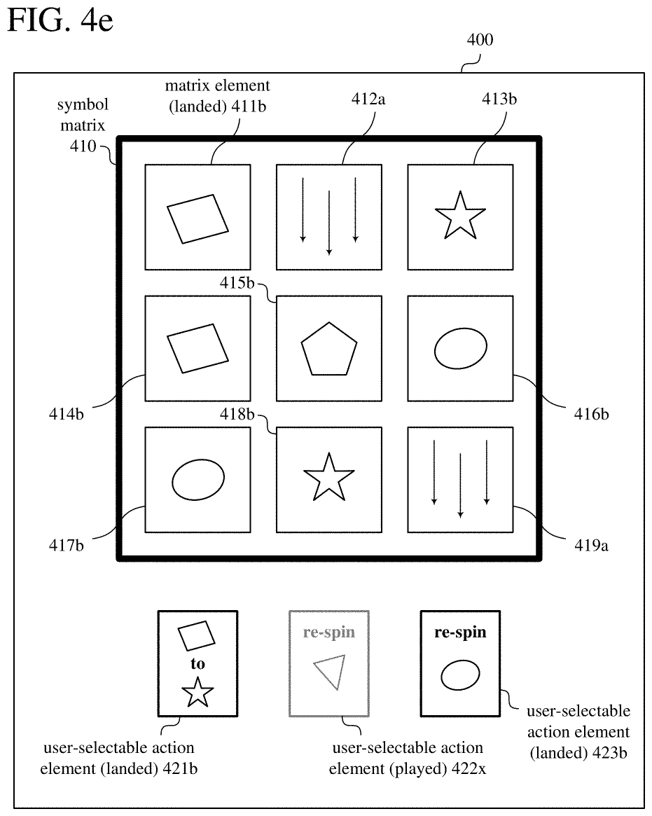

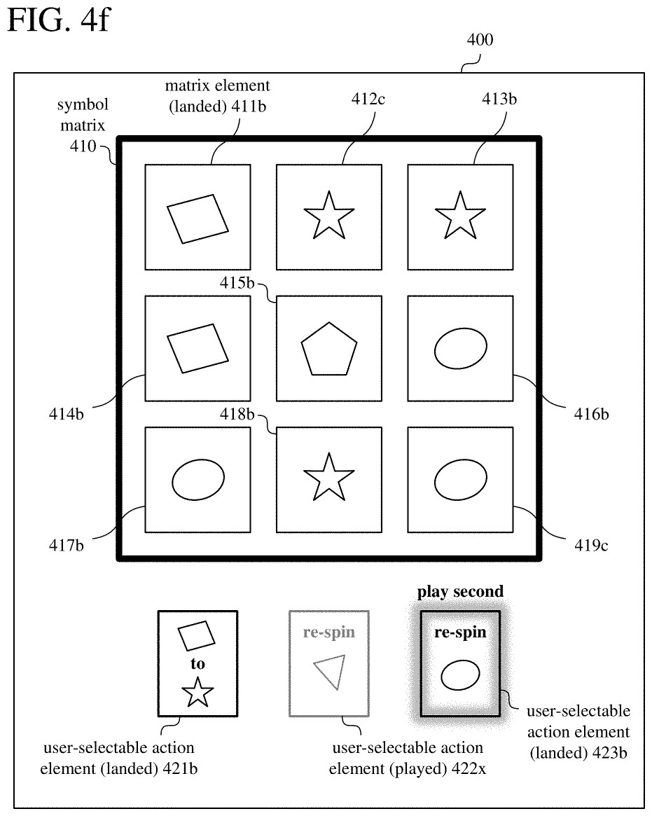

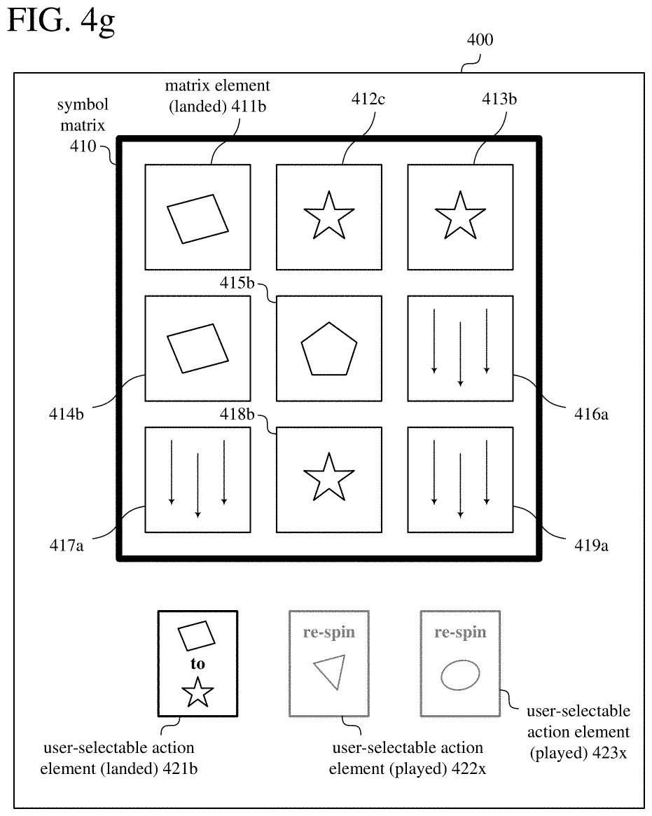

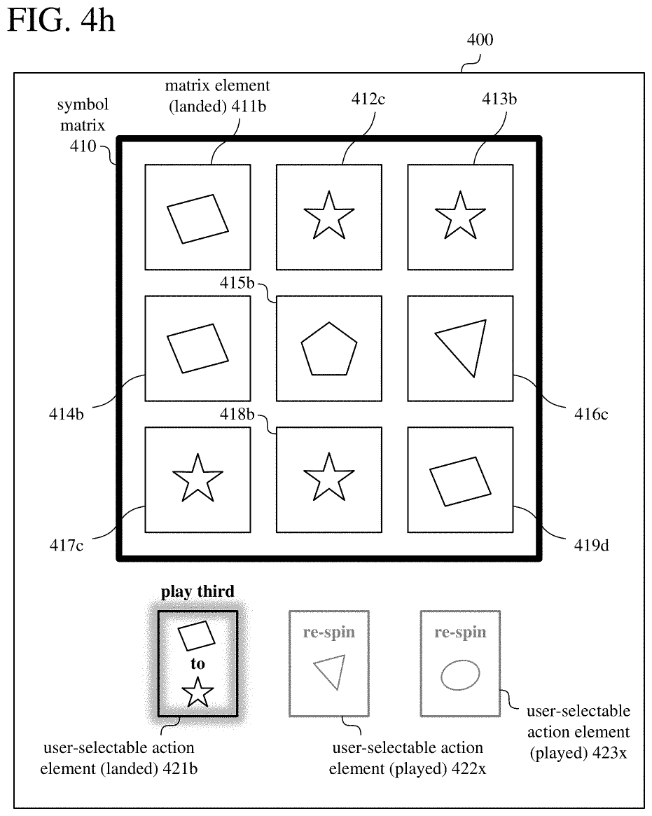

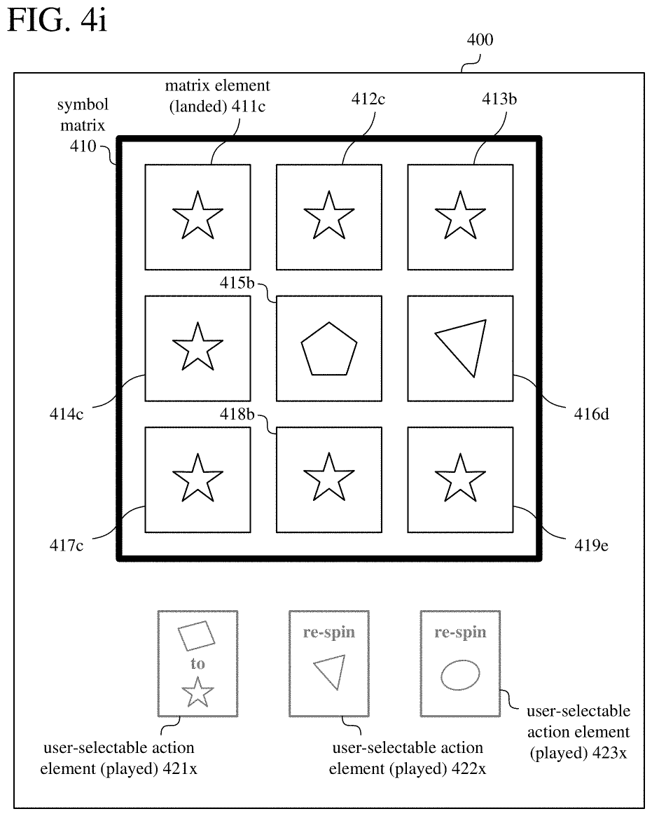

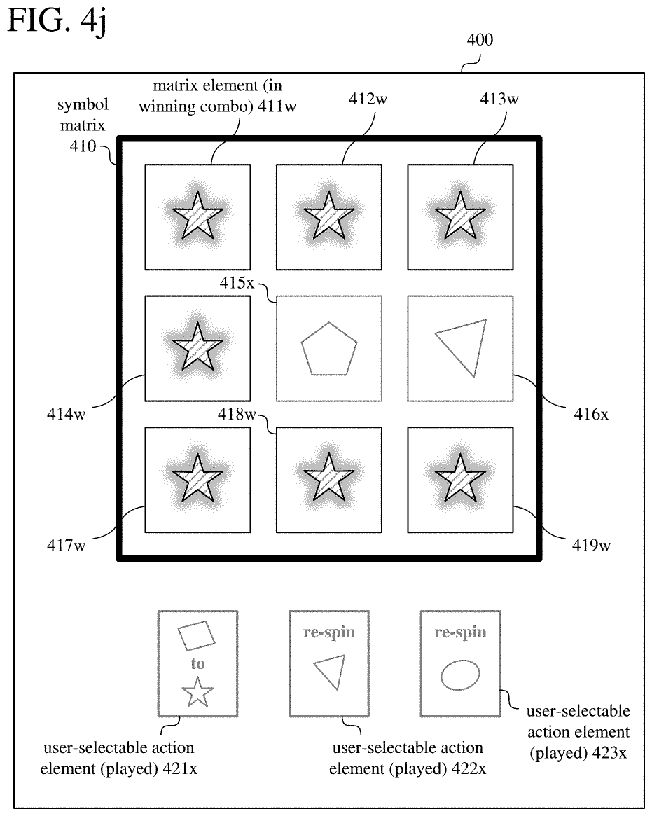

FIGS. 4a-4j show an example user interface (“UI”) 400 of an electronic gaming device that uses one or more sets of matrix elements and one or more sets of user-selectable action elements for an instance of a process (e.g., a play of a reel game). In the UI 400, the symbol matrix 410 includes multiple matrix elements 411-419, which are shown in different states through FIGS. 4a-4j. The symbol matrix 410 can be a reel area for multiple independent reels, a bingo card, a Keno card, or another game area. In general, the matrix elements 411-419 shown in the symbol matrix are determined based on randomly generated events (e.g., random numbers from one or more RNGs), but can later be modified when action elements are applied. In FIGS. 4a-4j, the symbol matrix 410 is a 3×3 configuration of matrix elements, with each of the matrix elements being associated with a set of matrix elements (such as a reel strip for a different, independent reel). Alternatively, the symbol matrix can have some other configuration, e.g., with a different number or arrangement of matrix elements.

The UI 400 also includes multiple user-selectable action elements 421-423, which are shown in different states through FIGS. 4a-4j. The action elements 421-423 can be cards, tiles, tokens, or some other type of graphical representation of operations to change matrix elements. In general, the action elements 421-423 are determined based on randomly generated events (e.g., random numbers from one or more RNGs), but a user subsequently decides whether and when to apply (play) the respective action elements 421-423. In FIGS. 4a-4j, there are three action elements 421-423, but alternatively some other number of action elements can be used. The action elements 421-423 can be selected from a single set of action elements (e.g., single deck of cards) or multiple sets of action elements (e.g., multiple sets of cards).

The UI 400 can include various controls (not shown) such as a “spin” button the player can actuate to start the instance of the process. Moreover, the UI 400 can include a supplemental display area (not shown) that includes additional information such as a timer, hint window, bet amount, bet denomination, available credits, and/or a win amount.

In FIG. 4a, the symbol matrix 410 includes matrix elements 411a-419a that have not yet been determined according to RNG events. The matrix elements 411a-419a are graphically depicted as “not landed” in the symbol matrix 410. For example, in FIG. 4a, the non-landed matrix elements 411a-419a are graphically depicted as spinning reels. The user-selectable action elements 421a-423a have also not yet been determined according to RNG events. The action elements 421a-423a are graphically depicted as not landed. For example, in FIG. 4a, the non-landed action elements 421a-423a are graphically depicted as cards that are “face down,” with a uniform back showing.

In FIG. 4b, the symbol matrix 410 includes matrix elements 411b-419b that have been determined according to RNG events. The matrix elements 411b-419b are graphically depicted as “landed” in the symbol matrix 410. For example, in FIG. 4b, different symbol instances are graphically depicted for the landed matrix elements 411b-419b. The user-selectable action elements 421b-423b have also been determined according to RNG events. The action elements 421b-423b are graphically depicted as landed. For example, in FIG. 4b, the landed action elements 421b-423b are graphically depicted as cards that are “face up,” with different graphics showing to represent different possible actions to change matrix elements. The first landed action element 421b graphically depicts an action to change quadrilateral symbol instances to star symbol instances. The second landed action element 422b graphically depicts an action to re-spin triangle symbol instances. The third landed action element 423b graphically depicts an action to re-spin oval symbol instances.

In FIG. 4c, the matrix elements 411b-419b and user-selectable action elements 421b-423b are unchanged, but the user has provided user input 430. Specifically, the user has provided user input that specifies the order in which to apply the landed action elements 421b-423b. The middle action element 422b is to be applied first, followed by the rightmost action element 423b, and followed by the leftmost action element 421b. An electronic gaming device can include physical buttons, touchscreen buttons, other virtual buttons, or other UI mechanisms for the user to provide the user input 430. For example, the electronic gaming device can include a button on, around, or otherwise associated with each of the action elements to select the action element to be applied and to specify the order to play the action element. (An action element can itself be a selectable “button” on a touchscreen.)

In FIG. 4d, the matrix elements 411b-419b are unchanged, but the middle user-selectable action element 422b has been graphically highlighted to indicate that it is about to be applied to affected ones of the matrix elements 411b-419b.

In FIG. 4e, two of the matrix elements 412b, 419b, which were graphically depicted as triangle symbol instances earlier, have been re-spun according to the middle action element 422b. The two matrix elements 412a, 419a are graphically depicted as “not landed” in the symbol matrix 410. For example, in FIG. 4e, the non-landed matrix elements 412a, 419a are again graphically depicted as spinning reels. Concurrently, the middle user-selectable action element 422x is graphically depicted as “played” (e.g., shown in a dimmed or grayed state).

In FIG. 4f, the two matrix elements 412a, 419a that were re-spun have been determined according to RNG events. The matrix elements 412c, 419c are graphically depicted as “landed” in the symbol matrix 410. For example, in FIG. 4f, symbol instances are graphically depicted for the two landed matrix elements 412c, 419c, which are different than the symbol instances for the two landed matrix elements 412b, 419b in FIGS. 4b-4d. (An identical symbol instance could land after a re-spin, however.) FIG. 4f also shows the rightmost user-selectable action element 423b as graphically highlighted, which indicates that the action element 423b is about to be applied to affected ones of the matrix elements in the symbol matrix 410.

In FIG. 4g, three of the matrix elements 416b, 417b, 419c, which were graphically depicted as oval symbol instances earlier, have been re-spun according to the rightmost action element 423b. The three matrix elements 416a, 417a, 419a are graphically depicted as “not landed” in the symbol matrix 410. For example, in FIG. 4g, the non-landed matrix elements 416a, 417a, 419a are again graphically depicted as spinning reels. Concurrently, the rightmost user-selectable action element 423x is graphically depicted as “played” (e.g., shown in a dimmed or grayed state).

In FIG. 4h, the three matrix elements 416a, 417a, 419a that were re-spun have been determined according to RNG events. The matrix elements 416c, 417c, 419d are graphically depicted as “landed” in the symbol matrix 410. For example, in FIG. 4h, symbol instances are graphically depicted for the three landed matrix elements 416c, 417c, 419d, which are different than the earlier symbol instances for the three landed matrix elements. (An identical symbol instance could land after a re-spin.) FIG. 4h also shows the leftmost user-selectable action element 421b as graphically highlighted, which indicates that the action element 421b is about to be applied to affected ones of the matrix elements in the symbol matrix 410.

In FIG. 4i, three of the matrix elements 411c, 414c, 419e, which were graphically depicted as quadrilateral symbol instances earlier, have been converted to star symbol instances according to the leftmost action element 421b. Concurrently, the leftmost user-selectable action element 421x is graphically depicted as “played” (e.g., shown in a dimmed or grayed state).

Finally, in FIG. 4j, the UI shows an indicator of the outcome of the instance of the process. The outcome of the instance of the process has been determined using the matrix elements in the symbol matrix 410. Specifically, matrix elements 411w, 412w, 413w, 414w, 417w, 418w, 419w in a winning combination are graphically depicted. In FIG. 4j, the winning combination is a seven-of-a-kind combination of star symbol instances. The remaining matrix elements 415x, 416x are graphically depicted as not being part of the winning combination (e.g., shown in a dimmed or grayed state). FIG. 4j depicts an example of an outcome determined using a “scatter pays” approach with one or more threshold counts for identical symbol instances. Other options for determining outcomes (e.g., using pay line evaluation, using ways evaluation) are described above.

B. Example Implementation Options.

The matrix elements and user-selectable action elements of an electronic gaming device can be configured in various ways, depending on implementation.

1. Example Arrangements and Types of Matrix Elements.

Depending on implementation, the count of matrix elements, arrangement of matrix elements, types of matrix elements, and other attributes of matrix elements can change. In some example implementations, a symbol matrix of a display screen of an electronic gaming device has nine independent reels in a 3×3 configuration, with a single matrix element (symbol instance) showing for each of the reels. For each of the reels, the reel strip is an example of a set of matrix elements. This is an example of a p×q configuration, as described above. Alternatively, a different configuration of independent reels can be used (e.g., more reels or fewer reels, in a square arrangement, rectangular arrangement, or other arrangement). Alternatively, reels in an m×n configuration or other configuration can be used, with each of the reels showing one or more matrix elements in a symbol matrix. Alternatively, a symbol matrix contains matrix elements for a bingo board, keno board, roulette wheel, or other game. The count and arrangement of matrix elements can be static. Or, the count and arrangement of matrix elements can be dynamic (e.g., changing depending on bet amount, bet denomination, loyalty reward status, a random event, a result of a previous instance of a process (e.g., big win), or some other factor) to provide more matrix elements, etc. as an enhancement or reward. In some examples, the count and arrangement of matrix elements can change when an action element is applied (e.g., to increase the number of matrix elements shown for a reel, or to otherwise increase the size of the symbol matrix).

In general, the matrix elements are depicted using symbol instances of different symbol types. The symbol types can include a highest-value symbol type, a high-value symbol type, various lower-value symbol types of different denominations, a wild symbol type, and a scatter symbol type. A symbol type can be a dynamic symbol type that is resolved to one of several different symbol types upon a spin. Alternatively, other and/or additional symbol types can be used.

2. Example Arrangements and Types of User-Selectable Action

Elements.

Depending on implementation, the count of user-selectable action elements, arrangement of user-selectable action elements, types of user-selectable action elements, and other attributes of user-selectable action elements can change. In some example implementations, three user-selectable action elements are determined for each instance of a process. Alternatively, more or fewer user-selectable action elements can be determined for each instance of a process. The count of user-selectable action elements can be static. Or, the count of user-selectable action elements can be dynamic (e.g., changing depending on bet amount, bet denomination, loyalty reward status, a random event, a result of a previous instance of a process, or some other factor), to provide more action elements as an enhancement or reward. In general, adding more user-selectable action elements can increase user interest by providing more options to evaluate, more control over an outcome, etc., but tends to slow down the rate of play.

Typically, the user-selectable action elements determined for an instance of a process are displayed adjacent the symbol matrix that contains matrix elements. For example, the action elements can be displayed above the symbol matrix, below the symbol matrix, or to one side of the symbol matrix. Alternatively, the action elements can be displayed in some other position or positions.

In general, a user-selectable action element can indicate any of various actions to change matrix elements. For example, a user-selectable action element can be associated with an operation to (a) convert one or more matrix elements from a first type (e.g., shape, color, size) to a second type different than the first type, (b) re-spin one or more matrix elements of a particular type (shape, color, size), thereby removing the matrix element(s) and using RNG events to replace the removed matrix element(s), and/or (c) make another change to one or more matrix elements. Alternatively, a user-selectable action element can indicate another type of action, which more generally affects how matrix elements are determined or evaluated, such as an operation to (d) add wild symbol instances to reel strips or otherwise modify reel strips, (e) re-size a symbol matrix (for a single reel or multiple reels), (f) add pay lines or ways to evaluate an outcome, (g) change a pay table used when evaluating an outcome, and/or (h) make another change to an attribute of the electronic gaming device.

In some example implementations, user-selectable action elements are graphically depicted as cards. Alternatively, user-selectable action elements can be graphically depicted as tiles selected from a container, faces of dice that are rolled, bingo balls selected from a hopper, etc.

In some example implementations, the one or more sets of user-selectable action elements are one or more decks of cards. More generally, a set of user-selectable action elements includes action elements of a particular type or types. Different sets of action elements can be used for different types of action elements (e.g., re-spin cards versus transform cards). Alternatively, a single set of action elements can be used for all types of action elements, or a given set of action elements can be used for multiple types of action elements (but not all types). In a lookup table for a set of action elements, the respective action elements can have equal weights. Or, the respective action elements have weights that vary for a set of action elements. The set(s) of action elements that are used for instances of a process can be static. Or, the set(s) of action elements that are used for instances of a process can be dynamic (e.g., changing depending on bet amount, bet denomination, loyalty reward status, a random event, a result of a previous instance of a process, or some other factor), to make valuable options more likely for the action elements as an enhancement or reward. For example, more valuable types of action elements can be “unlocked” or otherwise included in a set of action elements for a higher bet amount or higher bet denomination, or as a loyalty reward.

In some examples, there is no extra cost to apply an action element. That is, an action element can be applied for “free” after the action element has landed. In other examples, one or more types of action elements have an activation cost. That is, for such an action element to be applied, the activation cost for the action element must be paid. For example, the activation cost can be a cost in credits. The activation cost for an action element can be static or dynamic (e.g., changing depending on bet amount or bet denomination). By adjusting the activation costs for different types of action elements, a target RTP can be achieved, as explained below. Different approaches to setting activation costs for different types of action elements are described below.

In some examples, a type of user-selectable action element can be adaptively upgraded or downgraded. For example, the effect of applying a user-selectable action element can change to make the action element more powerful or less powerful. Such a change can trigger a change in the activation cost for the type of action element.

3. Example User Input for User-Selectable Action Elements.

In general, after one or more user-selectable action elements have been determined for an instance of a process, a user provides user input to indicate which of the action element(s) to apply and the order in which to apply the action element(s). For example, the user actuates a button or other UI feature on, around, or otherwise associated with a user-selectable action element to select. (An action element can itself be a selectable “button” on a touchscreen.) The order that the user selects multiple action elements indicates the order to apply the action elements. The user can actuate another button or UI feature to cause the selected action element(s) to be applied. In this way, the user can select all of the action elements, at least one but less than all of the action elements, or none of the action elements. Alternatively, user input can be provided in some other way to select which action elements, if any, to apply.

In some example implementations, after user-selectable action element(s) have been determined for an instance of a process, a user provides user input to indicate any or all of the action element(s) to apply. The selected action element(s) are then applied, one after the other, with results depicted for the matrix elements in the symbol matrix after the respective action element(s) are applied. Alternatively, after user-selectable action element(s) have been determined for an instance of a process, a user provides user input to indicate one of the action element(s) to apply. The selected action element is then applied, with results depicted for the matrix elements in the symbol matrix after the action element is applied. The user then provides user input to indicate another of the action element(s) to apply, and that selected action element is applied, with results depicted for the matrix elements in the symbol matrix. This process continues until all of the action element(s) have been applied or the user indicates no more action elements will be applied. This provides a way for the user to make decisions that account for results of applying earlier action elements (e.g., re-spin cards).

In some examples, a set of user-selectable action elements is reset for each instance of a process. In other examples, when an action element is applied in an instance of a process, the action element is removed from the set of action elements for subsequent instances of the process, until the set of action elements is reset.

4. Example Approaches to Determining Outcomes.

In some example implementations, an electronic gaming device determines the outcome for an instance of a process using scatter pays evaluation, as described elsewhere herein. Alternatively, an electronic gaming device can determine the outcome for an instance of a process using pay line evaluation, ways evaluation, or another approach as described elsewhere herein.

5. Accounting for User-Selectable Action Elements and a Target RTP.

User-selectable action elements add a skill-based decision factor to an electronic gaming device, which otherwise may be engineered to expect that outcomes depend on random events. Different possible combinations of action elements might not be balanced with regard to RTP. Adjustments can be made to how matrix elements are determined, how outcomes are determined for instances of a process, and/or which activation costs are assigned for various types of action elements, so that a target RTP is achieved, on average, across a large number of instances of the process. The adjustments to how matrix elements are determined can include, for example, swapping reel strips for reels associated with matrix elements, modifying reel strips for reels associated with matrix elements (to add wild symbol instances, remove wild symbol instances, or add or remove other symbol instances), changing weights in lookup tables for reels associated with matrix elements, changing how dynamic symbol resolution is performed (by changing the lookup table used for symbol instance selection or otherwise changing how dynamic symbol resolution happens), or making other changes. Adjustments to how outcomes are determined for instances of a process can include, for example, changing pay lines or ways evaluation, changing a pay table, or making other changes. Activation costs can be set for different types of action elements, for example, to assign a non-zero activation cost to more powerful action elements and assign an activation cost of zero (no activation cost) to regular action elements. More generally, different activation costs can be assigned to some or all types of action elements, so as to vary activation cost according to the power of the respective action elements in a more fine-grained way. For example, for a type of action element that tends to result in a higher award, the activation cost for the type of action element can be increased to a higher number of credits, so as to lower RTP to a target level. Or, as another example, for a type of action element that tends to result in a lower award, the activation cost for the type of action element can be decreased to a lower number of credits, so as to raise RTP to a target level. Applicable rules about showing changes to a player can be followed, or they can limit which adjustments are made.

Results of simulations can be used to determine how to achieve a target RTP when user-selectable action elements may be applied. For example, simulation is used to determine expected outcomes for instances of a process that uses k cards per instance, where k is a number such as 3, and the k cards are selected from one or more decks of cards. For each possible combination of k cards, and for each possible permutation (play order) for the combination of k cards, a large number of rounds of determination of matrix elements are performed (simulated) using RNG events. An average RTP is estimated for that combination of k cards. The estimate of the average RTP for the combination of k cards can assume, for example, that the most promising permutation is always selected. Whatever assumption is made, the estimates of average RTP for the different possible combinations of k cards are evaluated to determine an overall average RTP. At that point, adjustments can be made to how matrix elements are determined, how outcomes are determined for instances of a process, and/or which activation costs are assigned for various types of action elements, as described above, so as to make the overall average RTP match a target level of RTP across a large number of instances of the process. In this way, activation costs for different types of action elements can be set in a way that accounts for the combinations in which the action elements can be used. Such adjustments are independent of the combination of k cards actually determined for a given instance of the process. After such adjustments, some possible combinations of k cards will still have higher estimated RTP than other possible combinations of k cards, but across enough instances of the process (assuming a random distribution of different combinations of k cards in those instances), the target RTP will be achieved.

According to such approaches, a user can bring his/her own deck(s) of cards (or other custom set(s) of user-selectable action elements) to an electronic gaming device. After the user loads the custom set(s) of action elements, simulations can be run to estimate overall average RTP when the custom set(s) of action elements are used. At that point, adjustments can be made to how matrix elements are determined, how outcomes are determined for instances of a process, and/or which activation costs are assigned for various types of action elements, as described above, such that the overall average RTP matches a target level of RTP across a large number of instances of the process. To make a custom set of user-selectable action elements, a user can select from among pre-defined types of user-selectable action elements. Or, in other examples, a user can define a new type of user-selectable action element, setting one or more effects of applying the action element. An effect for an action element can depend on the action element being played by itself. Or, for a synergistic effect, an effect for an action element can depend on the action element being played in combination with one or more other action elements. An activation cost can be assigned to the new type of action element when a set of action elements including the new type is loaded.

Similarly, according to such approaches, different options can be implemented for different counts of user-selectable action elements, different types of user-selectable action elements, different counts of matrix elements, or different types of matrix elements. For a given combination of options, simulations can be run to estimate overall average RTP when the given combination of options is used. At that point, adjustments can be made to how matrix elements are determined, how outcomes are determined for instances of a process, and/or which activation costs are assigned for various types of action elements, as described above, such that the overall average RTP matches a target level of RTP across a large number of instances of the process.

6. Balancing Overall RTP for Different Combinations of User-Selectable Action Elements.

In general, the timing of (a) determination of user-selectable action elements for an instance of a process versus (b) determination of matrix elements for the instance of the process can vary depending on implementation. In particular, such timing can depend on whether possible combinations of action elements are already balanced with regard to RTP.

In some architectures, it may be required for different possible combinations of user-selectable action elements to be at least roughly equivalent in terms of RTP. (Any given combination is not supposed to be better than the others.) For such architectures, if different possible combinations of action elements are balanced with regard to RTP, the matrix elements can be determined before (or after) the action elements for an instance of a process, without adjustments to how the matrix elements are determined. In this case, the RNG events to determine the matrix elements for an instance of a process can happen before the RNG events to determine the action element(s) for the instance of the process.

On the other hand, for such architectures, if the different possible combinations of user-selectable action elements are not balanced with regard to RTP, adjustments can be made to how matrix elements are determined for an instance of a process, given a specific combination of action elements for the instance of the process, so as to balance overall RTP between instances of the process. Specifically, after action element(s) for an instance of a process have been determined, but before matrix elements for the instance of the process have been determined, adjustments can be made to balance RTP. The adjustments can include, for example, swapping reel strips for reels associated with matrix elements, modifying reel strips for reels associated with matrix elements (to add wild symbol instances, remove wild symbol instances, or add or remove other symbol instances), changing weights in lookup tables for reels associated with matrix elements, changing how dynamic symbol resolution is performed, or making other changes. Applicable rules about showing changes to a player can be followed, or they can limit which adjustments are made.

Alternatively, for such architectures, if the different possible combinations of user-selectable action elements are not balanced with regard to RTP, adjustments can be made to how outcomes are determined for instances of a process and/or which activation costs are assigned for various types of action elements, given a specific combination of action elements for the instance of the process, so as to balance overall RTP between instances of the process. For example, adjustments can be made to how outcomes are determined for instances of a process and/or which activation costs are assigned for various types of action elements, as described above.

Results of simulations can be used to determine how to balance RTP for different possible combinations of user-selectable action elements. For example, simulation is used to determine expected outcomes for instances of a process that uses k cards per instance, where k is a number such as 3, and the k cards are selected from one or more decks of cards. For a possible combination of k cards, a large number of rounds of determination of matrix elements are performed (simulated) using RNG events for each possible permutation (play order) for that combination of k cards, and an average RTP is estimated for that combination of k cards. The estimate of the average RTP for the combination of k cards can assume the most promising permutation is selected. At that point, for the combination of k cards, adjustments can be made to how matrix elements are determined so that the estimated average RTP for that combination at least approximately matches a target level of RTP. Thus, for a combination of k cards having an estimated average RTP that is “too high,” adjustments can be made to how matrix elements are determined so that the estimated average RTP decreases. Or, for a combination of k cards having an estimated average RTP that is “too low,” adjustments can be made to how matrix elements are determined so that the estimated average RTP increases. Alternatively, for the combination of k cards, adjustments can be made to how outcomes are determined for instances of a process and/or which activation costs are assigned for various types of action elements, so that the estimated average RTP for that combination at least approximately matches a target level of RTP. Depending on implementation, such simulations and adjustments can be performed on the fly, after a combination of action elements has been determined. Or, such simulations and adjustments can be performed in advance for various combinations, with information that indicates the adjustments for different combinations being stored, and the appropriate adjustments can be performed on the fly after a specific combination of action elements has been determined.

In a typical architecture, an RNG engine determines stop positions for all spinning reels, which are RNG-event-based reels. The processing pipeline for such an architecture can be modified to (1) receive a notification indicating a combination of user-selectable action elements, and (2) react to the notification to balance overall RTP (e.g., by adjusting reel strips, lookup tables, dynamic symbol resolution, etc. for the RNG-event-based reels). Typically, a backend system is local to an electronic gaming device or connected by a fast network connection to the frontend system for the electronic gaming device, such that delay is not problematic. Adjustments for the RNG-event-based reels can happen without introducing delay that is perceptible to the player. Similarly, adjustments to how outcomes are determined for instances of a process and/or which activation costs are assigned for various types of action elements can happen without introducing delay that is perceptible to the player.

7. Other Options.

In some example implementations, an electronic gaming device can display a hint window that presents information about different strategies for applying user-selectable action elements. For example, after one or more user-selectable action elements have been determined for an instance of a process, a backend system can evaluate possible permutations for applying the action element(s) and send information indicating, for each of the evaluated permutations, an expected outcome for that permutation. A UI system can receive such information and display the expected outcomes for the multiple possible permutations, respectively, in a hint window.

A hint window can be shown automatically for each instance of a process. Or, a hint window can be shown responsive to actuation of a button or other UI feature by the user. In general, the hint window can increase rate of play by helping a user avoid stalling at the point of a decision about which user-selectable action elements to apply.

As another example, an electronic gaming device can display a window that presents information about the effects and/or activation costs for different user-selectable action elements. For example, a backend system can look up and send information indicating, for each of the action elements, the effect(s) of applying the action element and the activation cost for applying the action element. A UI system can, for each of the action elements, receive such information and display the information in a window

As another example, a timer can be displayed, depicting an amount of time to provide user input that indicates how to apply the user-selectable action element(s) for an instance of a process. For example, after the action element(s) and matrix elements for an instance of a process are displayed, a user can be given 15 seconds, 20 seconds, or some other amount of seconds to provide user input about the action element(s), if any, to apply. The timer can increase rate of play by forcing a user avoid stalling at the point of a decision about which action elements to apply.

The innovations described herein can be used in a multiplayer setting, for example, with multiple players sharing a symbol matrix and user-selectable action elements, and collectively providing user input about which of the action elements to apply. Multiplayer play can be cooperative or competitive.

C. Example Techniques for Controlling the UI of an Electronic Gaming Device that Uses Set(s) of Matrix Elements and Set(s) of User-Selectable Action Elements.

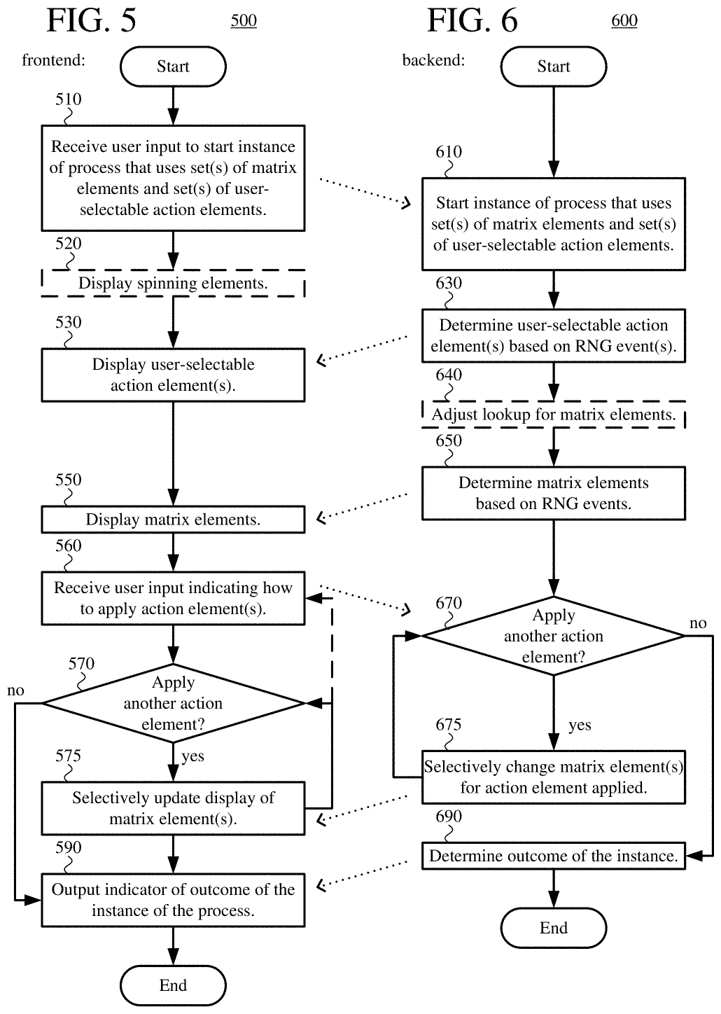

FIGS. 5 and 6 show example techniques for controlling the UI of an electronic gaming device such as an electronic gaming machine (“EGM”), which uses one or more sets of matrix elements and one or more sets of user-selectable action elements. The example technique 500 of FIG. 5 focuses on UI frontend activity, whereas the example technique 600 of FIG. 6 focuses on backend activity. Operations of the example technique 500 shown in FIG. 5 can be performed, for example, in a UI system 302 explained with reference to FIG. 3. Operations of the example technique 600 shown in FIG. 6 can be performed, for example, in a game processing backend system 314 explained with reference to FIG. 3. The game processing backend system and UI system can be implemented using memory and one or more processors that are part of the electronic gaming device and/or part of a gaming system located remotely from the electronic gaming device. Depending on implementation, the backend system and UI system can be implemented by software executable on a CPU, by software controlling special-purpose hardware (e.g., a GPU or other graphics hardware for video acceleration), and/or by special-purpose hardware (e.g., in an ASIC), to process game play instructions in accordance with game play rules, determine outcomes in accordance with game play rules, and/or generate outputs (e.g., to one or more display screens and/or speakers).

In general, the example techniques 500, 600 shown in FIGS. 5 and 6 use one or more symbol matrices on one or more display screens of an electronic gaming device. The one or more symbol matrices can be displayed on a single display screen (e.g., main display screen, or secondary display screen). Or, the one or more symbol matrices can be split among multiple display screens (e.g., one symbol matrix on a first display screen, and another symbol matrix on a second display screen). The number of symbol matrices depends on implementation. As used herein, the term “game window” or “reel area” can be used interchangeably as an example of a symbol matrix.

In the techniques 500, 600 shown in FIGS. 5 and 6, respectively, a process uses one or more sets of matrix elements and one or more sets of user-selectable action elements. In some example implementations, the process is a reel game, and each of the set(s) of matrix elements is a reel strip for a different, independent reel. For UI-focused operations, the reel strip can be displayed as spinning in a symbol matrix on a display screen of the electronic gaming device upon a spin of the reel. In this case, the matrix elements are symbol instances on reel strips of reels. Alternatively, the process can be another type of process such as a bingo game, keno game, or other game, and the set(s) of matrix elements can be a set of bingo balls, a set of keno numbers, or a set of some other type of matrix element. In some example implementations, each the set(s) of action elements is a different deck of cards. In this case, the action element(s) are one or more cards selected from the different deck(s) of cards. Alternatively, the action elements are tiles, tokens, or some other type of graphical representation of operations to change matrix elements.

1. Example UI Frontend Operations.

With reference to FIG. 5, at stage 510, a UI system (such as the UI system 302 described with reference to FIG. 3) receives user input at the electronic gaming device. The user input indicates a start to an instance of a process that uses one or more sets of matrix elements and one or more sets of user-selectable action elements. For example, the user input that indicates to start the instance of the process is a button press of a physical button, touchscreen button, or other virtual button. The UI system sends a notification to the backend system of the user input, or otherwise notifies the backend system that the instance of the process should be started (as shown by the dotted line from stage 510).

After receiving the user input that indicates to start the instance of the process, the UI system can display (stage 520) spinning elements in positions for the matrix elements. For example, the UI system displays spinning reels in the symbol matrix.

In some example implementations, the symbol matrix contains matrix elements arranged in a p×q configuration. Each of the matrix elements is associated with a different, independent reel (having a reel strip that is one of the set(s) of matrix elements). Alternatively, the matrix elements can be arranged in some other configuration.

As shown by the dotted line to stage 530, the UI system receives one or more notifications that indicate one or more user-selectable action elements. The backend system has determined, from the set(s) of action elements, the action element(s) based at least in part on one or more RNG events. At stage 530, the UI system displays the action element(s).

As shown by the dotted line to stage 550, the UI system also receives one or more notifications that indicate matrix elements (e.g., as stop positions for the reel strips of reels). The backend system has determined, from the set(s) of matrix elements, the matrix elements based at least in part on RNG events. At stage 550, the UI system displays the matrix elements. For example, for each of the matrix elements, the UI system stops a reel strip for a reel at a stop position that has been determined based at least in part on a random number generated by the RNG. The UI system checks whether there are any more reels to stop and, if so, continues for the next reel. Thus, the matrix elements can “land” one at a time. Alternatively, the matrix elements can land together or according to some other timing.

In general, the matrix elements are organized in a symbol matrix, and the user-selectable action element(s) are displayed adjacent the symbol matrix (e.g., below the symbol matrix, above the symbol matrix, or to the side of the symbol matrix). Alternatively, the action elements can be displayed in some other position or positions. The displaying the action element(s) can precede the displaying the matrix elements, or the displaying the action element(s) can follow the displaying the matrix elements.

At stage 560, the UI system receives, from the user, user input that indicates how, if at all, to apply the user-selectable action element(s). For example, the user input that indicates how to apply the action element(s) indicates: (a) for each of the action element(s), whether or not to apply that action element, and/or (b) an order to apply the action element(s), if at all. Thus, the user can specify that all of the action element(s) are to be applied, that one or more but less than all of the action element(s) are to be applied, or that none of the action element(s) are to be applied. After receiving the user input that indicates how to apply the action element(s), the UI system sends (to the backend system) information that indicates how to apply the action element(s), as shown by the dotted line from stage 560. Notifications to the backend system indicating how to apply the action element(s) can be batched and sent together.

As shown by the dotted line to stage 575, the UI system receives one or more notifications that indicate how display of the matrix elements should be updated, if at all, based on the user-selectable action element(s) that have been applied. Notifications from the backend system indicating how the matrix elements have been changed, if at all, can be batched and sent together, or they can be sent one at a time as the respective action elements are applied. In any case, the UI system selectively updates display of those of the matrix elements that have changed, for one action element at a time. Specifically, the UI system checks (stage 570) whether there is another action element to apply to the matrix elements and, if so, selectively updates (stage 575) display of one or more of the matrix elements as indicated by the backend system. Thus, for each of action element(s) that has been applied by the user, the UI system makes changes to display of those of the matrix elements, if any, that are affected by the action element.

In some example implementations, the UI system receives user input for any and all of the user-selectable action element(s) that will be applied, sends a notification to the backend system indicating how to apply the action element(s), and receives one or more notifications from the backend system, indicating how the respective action element(s) have been applied. Alternatively, for one user-selectable action element at a time, the UI system can interleave operations to (a) receive user input indicating an action element to apply and (b) selectively update display of the matrix elements to show how the action element has been applied. This allows the user to make decisions about whether and when to play a subsequent action element based on results from application of an earlier action element.

At stage 590, the UI system outputs an indicator of an outcome of the instance of the process. As shown by the dotted line to stage 590, the UI system receives a notification from the backend system that specifies the outcome. The outcome is based at least in part on the matrix elements in the symbol matrix after the selective changes. Depending on implementation, for example, the outcome can be evaluated according to a scatter pay evaluation approach, pay line evaluation approach, ways evaluation approach, or other evaluation approach. For example, the indicator of the outcome is a graphical indicator for a win amount, such as an animation or other graphical depiction for the win amount, which can be accompanied by audio output.

2. Example Backend Operations.

With reference to FIG. 6, at stage 610, a backend system (such as the game processing backend system 314 described with reference to FIG. 3) starts an instance of a process that uses one or more sets of matrix elements and one or more sets of user-selectable action elements. The backend system receives a notification (with an indicator based on user input) from the UI frontend system, indicating that the instance of the process should be started, as shown by the dotted line to stage 610.

At stage 630, the backend system determines, based at least in part on one or more RNG events, one or more user-selectable action elements from the set(s) of action elements. For example, for each of the action element(s), the backend system generates a random number and determines, based at least in part on the random number, the action element from a given set of the set(s) of action elements. To do so, the backend system can determine an identifier using a lookup table, which includes entries that indicate identifiers for different action elements in the given set. After determining the action element(s), the backend system sends information (in one or more notifications to the UI system) that indicates the action element(s), as shown by the dotted line from stage 630. The notifications to the UI system can be batched and sent together, or they can be sent one at a time as the respective action elements are determined.

In some example implementations (as shown in FIG. 6), the backend system determines (stage 630) the user-selectable action element(s) before determining (stage 650) matrix elements. This permits the backend system to adjust (stage 640), before determining the matrix elements, how to perform the determining the matrix elements. Specifically, the backend system can adjust how to determine the matrix elements based on the action element(s) that have been determined (stage 630), so as to balance overall RTP between different possible combinations of action elements. For example, for a given set of matrix elements, the backend system can adjust: (a) a reel strip, (b) a lookup table associated with the given set, (c) how dynamic symbols are resolved for the reel strip, and/or (d) another mechanism or attribute. Alternatively, the backend system can adjust how outcomes are determined for instances of a process and/or which activation costs are assigned for various types of action elements, so as to balance overall RTP between different possible combinations of action elements. The activation cost for an action element can be an amount of credits, a monetary value, or another amount. In this way, the backend system can balance overall RTP for the instance of the process in view of the varying RTP associated with different possible combinations of the action element(s) that may be determined.

Alternatively, if different possible combinations of user-selectable action elements are balanced with respect to RTP, the technique 600 can omit the adjustments at stage 640. In some examples, at least some different action elements in the set(s) of action elements have different activation costs, which have been assigned so that different possible combinations of action elements of the set(s) of action elements are balanced with respect to RTP. Different activation costs can be different amounts of credits, different monetary values, or other amounts. The activation costs for respective action elements of a set of action elements can be determined in advance for an electronic gaming device. Or, the activation costs for respective action elements of a set of action elements can be determined when the set of action elements is “loaded” for an electronic gaming device. Or, if RTP need not be balanced between different possible combinations of action elements, the technique can omit the adjustments at stage 640. In either of these cases, the backend system can determine the action element(s) after determining the matrix elements.

At stage 650, the backend system determines, based at least in part on RNG events, matrix elements from the set(s) of matrix elements. For example, for each of the matrix elements, the backend system generates a random number and determines, based at least in part on the random number, the matrix element from a given set of the set(s) of matrix elements. To do so, the backend system can determine a stop position, for a reel strip of a reel associated with the matrix element, using a lookup table, which includes entries that indicate different stop positions of the reel strip for the reel. The random numbers for multiple matrix elements can be determined before corresponding lookup operations for those matrix operations, or a random number can be generated and used in a lookup operation for one matrix element at a time. After determining the matrix elements, the backend system sends information (in one or more notifications to the UI system) that indicates the matrix elements, as shown by the dotted line from stage 650. The notifications to the UI system can be batched and sent together, or they can be sent one at a time as the respective matrix elements are determined.

The backend system receives (from the UI system) information that indicates how, if at all, to apply the user-selectable action element(s), as shown by the dotted line to stage 670. Notifications to the backend system indicating how, if at all, to apply the action element(s) can be batched and sent together, or they can be sent one at a time. The user can specify that all of the action element(s) are to be applied, that at least one but less than all of the action element(s) are to be applied, or that none of the action element(s) are to be applied.

In any case, assuming that at least one of the user-selectable action element(s) is to be applied, the backend system selectively changes at least one of the matrix elements according to any of the action element(s) that has been applied by the user, for one action element at a time. Specifically, the backend system checks (stage 670) whether there is another action element to apply to the matrix elements and, if so, selectively changes (stage 675) one or more of the matrix elements. For each of action element(s) that has been applied by the user, the backend system determines which of the matrix elements, if any, are affected by the action element, and makes changes to those of the matrix elements, if any, that are affected by the action element.

The operations performed for an action element depend on implementation. For example, for a given matrix element, the backend system determines, based at least in part on another RNG event, a new matrix element to replace the given matrix element. In this way, the backend system can “re-spin” the given matrix element. Or, as another example, for a given matrix element, the backend system converts the given matrix element from a first type to a second type different than the first type. In this way, the backend system can “transform” the given matrix element in a deterministic way. More generally, the operations can include: (a) re-spinning those of the matrix elements that are affected by the action element, (b) converting those of the matrix elements that are affected by the action element from a first type to a second type different than the first type, and/or (c) making some other change to those of the matrix elements that are affected by the action element. Alternatively, the changes can include changes to how matrix elements are determined or evaluated for an outcome, such as: (d) adding wild symbol instances to the set(s) of matrix elements or otherwise modifying the set(s) of matrix elements, (e) re-sizing the symbol matrix (for a single reel or multiple reels), thereby increasing count of the matrix elements, (f) adding one or more pay lines or ways to be evaluated in the determining the outcome, (g) changing a bet level, (h) changing a pay table, and/or (i) making some other type of change.

After selectively changing the matrix element(s), the backend system sends (to the UI system) information that indicates any matrix elements that have been changed by the action element(s) and, hence, how to update display of the matrix element(s) affected by the application of the action element(s), as shown by the dotted line from stage 675. Such notifications can be batched and sent together, or they can be sent one at a time.

In some example implementations, the backend system receives information that indicates any and all of the action element(s) that will be applied, selectively changes the affected matrix elements (if any) for the respective action element(s), and sends one or more notifications to the UI system, indicating how the respective action element(s) have been applied (e.g., any changed matrix elements). Alternatively, for one action element at a time, the backend system can interleave operations to (a) receive information indicating the action element to apply, (b) selectively change the affected matrix elements (if any) for the action element, and (c) send information that indicates how the action element has been applied (e.g., any changed matrix elements). This allows the user to make decisions about whether and when to play a subsequent action element based on results from application of an earlier action element.

At stage 690, the backend system determines, based at least in part on the matrix elements after the selective changes, an outcome of the instance of the process. For example, the backend system determines the outcome using scatter pay evaluation based on one or more threshold counts of matrix elements. Or, as another example, the backend system determines the outcome using pay line evaluation for one or more pay lines across a matrix containing the matrix elements. Or, as another example, the backend system determines the outcome using ways evaluation across a matrix that contains the matrix elements. In this case, the outcome depends on win conditions for combinations of symbol instances along possible paths through active symbol display positions of the matrix, where, for each of the possible paths through the active symbol display positions of the matrix, the possible path uses one of the symbol instances per column and crosses the matrix from one side of the matrix to an opposite side of the matrix. Or, as another example, the backend system determines the outcome of the instance of the process in some other way.

D. Example Implementations.

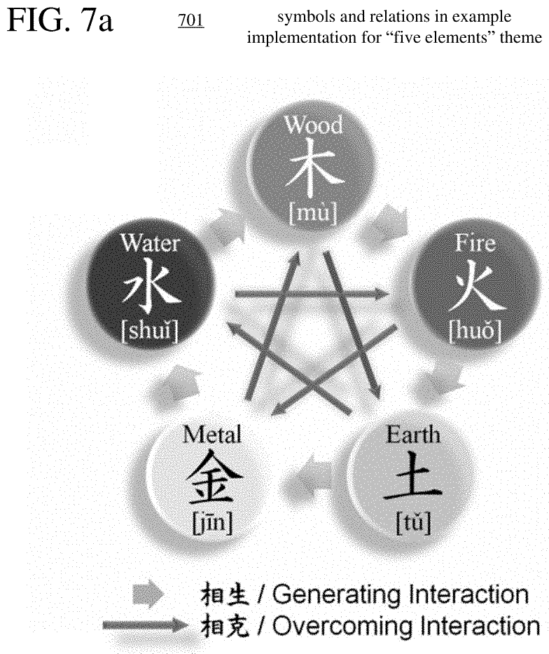

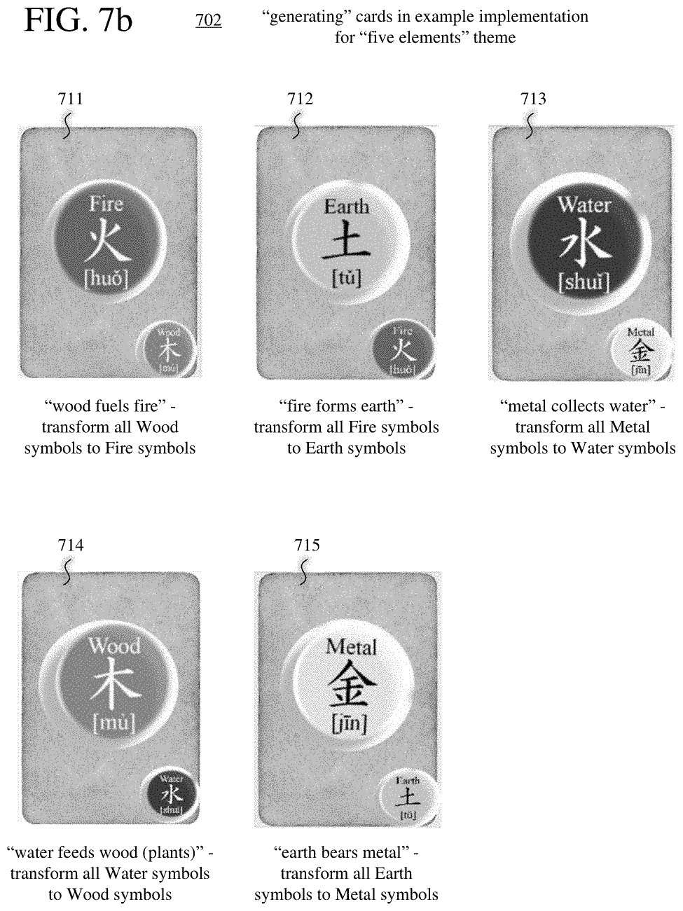

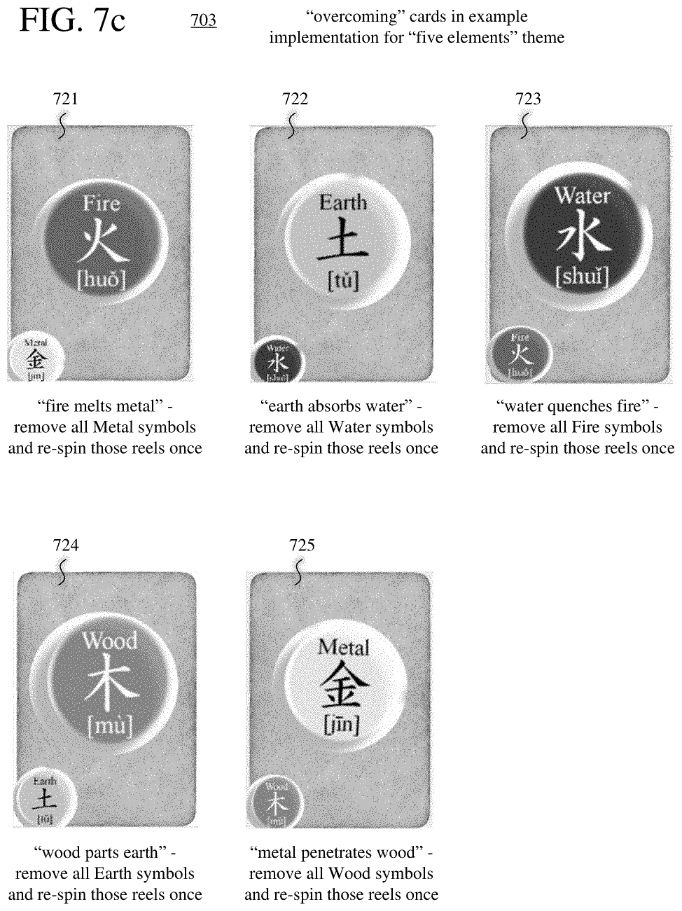

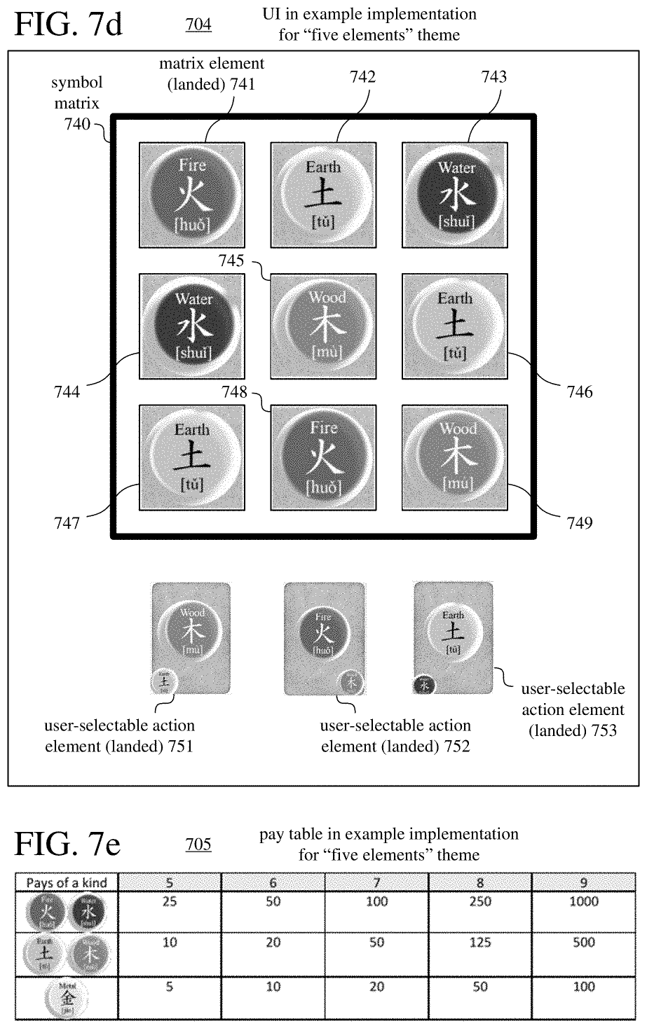

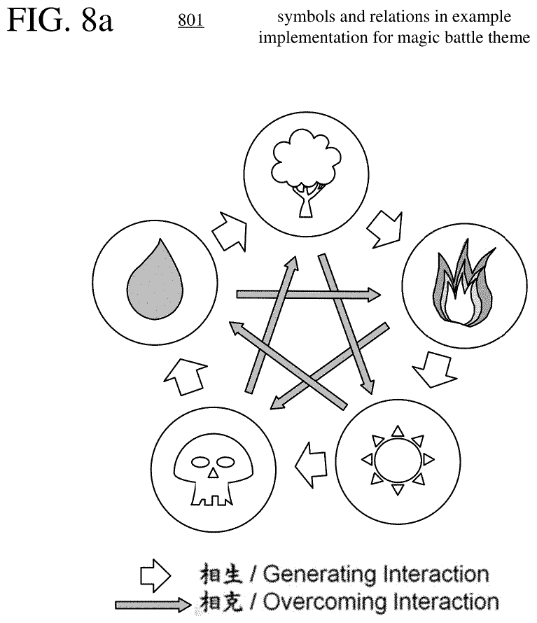

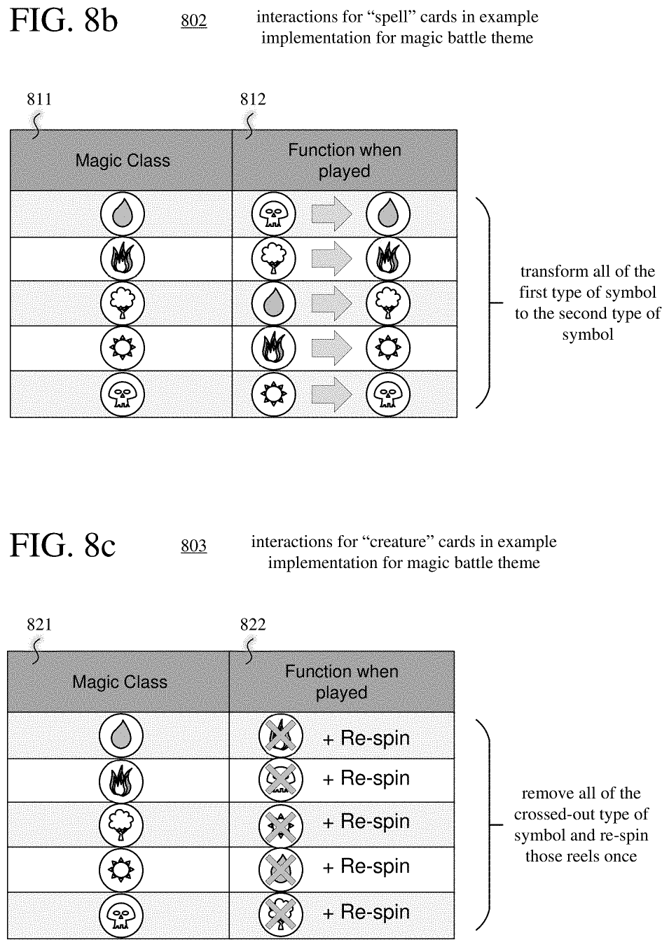

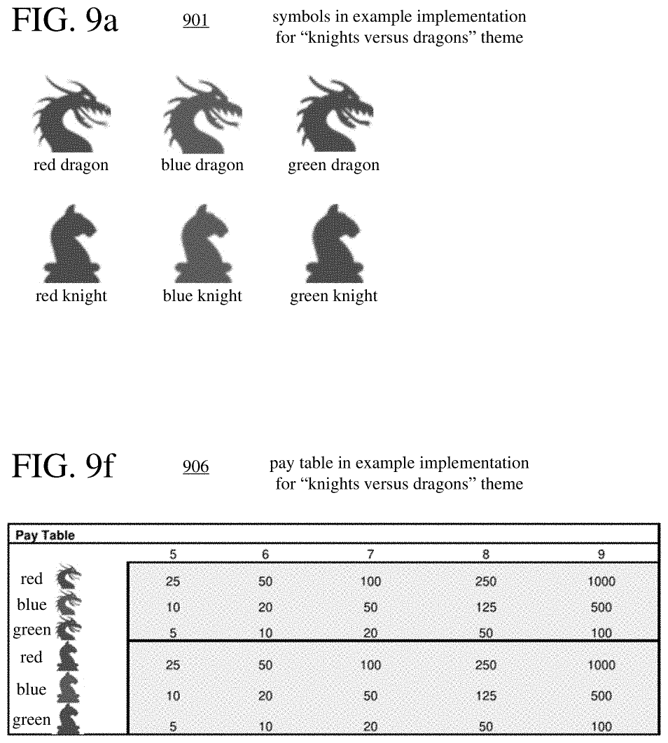

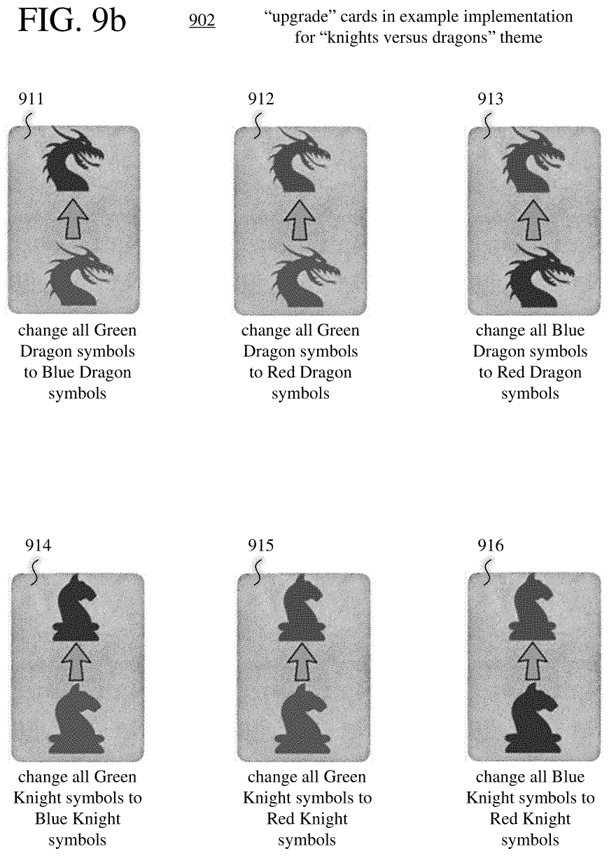

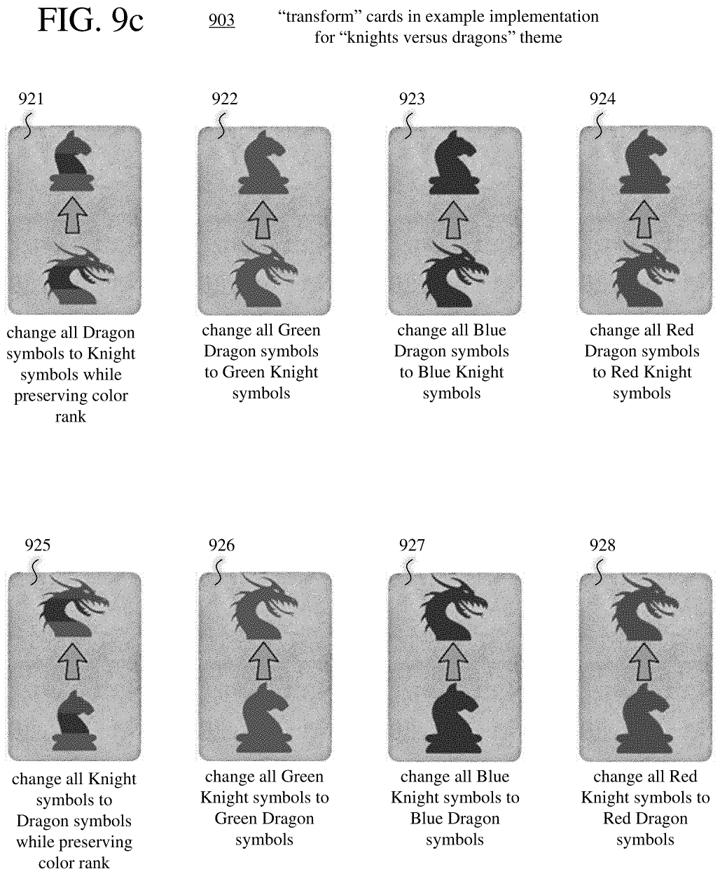

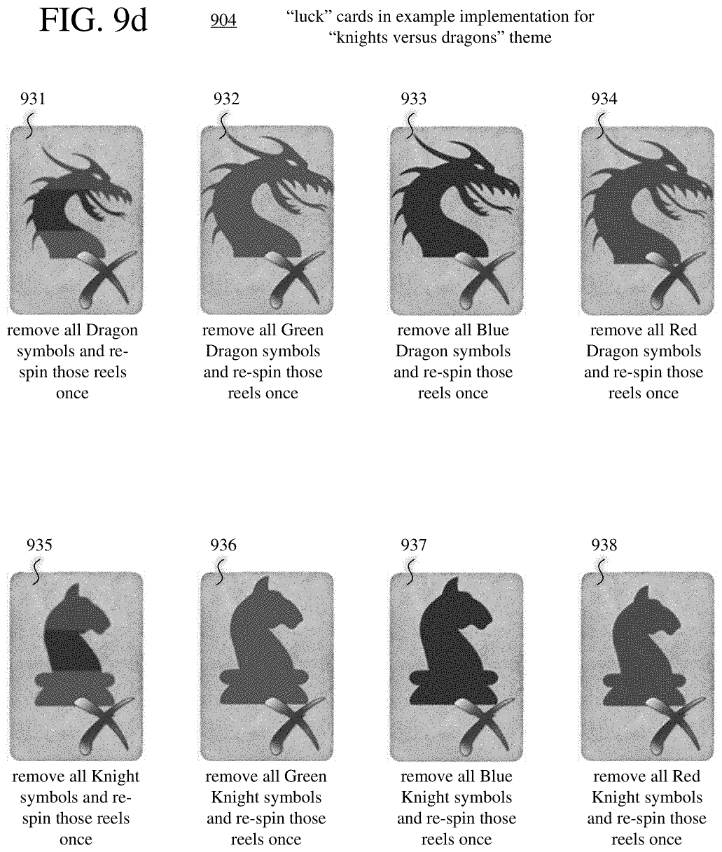

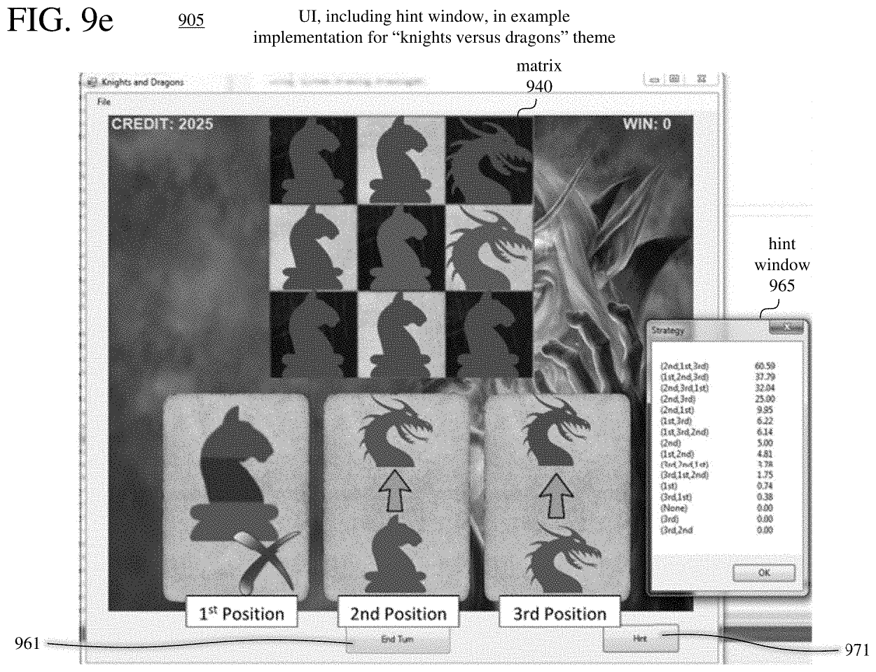

FIGS. 7a-7e, 8a-8c, and 9a-9f show different features of example implementations of an electronic gaming device that uses one or more sets of matrix elements and one or more sets of user-selectable action elements.

1. Example Five Elements Implementation.

FIGS. 7a-7e show different features of a first example implementation of an electronic gaming device, which uses sets of matrix elements for nine independent reels and uses two sets of user-selectable action elements, following a “five elements” theme. The first example implementation combines a slot reel mechanic for matrix elements in a symbol matrix with card playing aspects for the action elements.

In Chinese philosophy, five elements theory describes interactions and relationships between things. According to five elements theory, wood, fire, earth, metal, and water are fundamental elements between which interactions occur. FIG. 7a shows symbol instances for the five elements and relationships 701 between the five elements. There are two types of interactions: generating interactions and overcoming interactions. In the first example implementation, a generating interaction corresponds to a transformation of a matrix element from a first type to a second type different than the first type. An overcoming interaction corresponds to a re-spin of a matrix element.

In the first example implementation, a matrix element is a symbol instance that depicts one of the five elements. FIG. 7a shows example symbol instances for the five elements. Each matrix element is associated with a different, independent reel. The reel strip for a reel includes w symbol instances, where w depends on implementation. For example, w is 60, 80, or some other number. Each of the symbol instances in the reel strip is one of five distinct symbol types, as shown in FIG. 7a.

FIG. 7b shows example cards 702 of a first deck of cards, for generating interactions in the first example implementation. The first deck of cards consists of x cards, where x depends on implementation. For example, x is 20, 30, or some other number. Each of the cards in the first deck is one of five distinct card types, as shown in FIG. 7b. A first card type 711 transforms any Wood symbol instances among matrix elements to Fire symbol instances. A second card type 712 transforms any Fire symbol instances among matrix elements to Earth symbol instances. A third card type 713 transforms any Metal symbol instances among matrix elements to Water symbol instances. A fourth card type 714 transforms any Water symbol instances among matrix elements to Wood symbol instances. Finally, a fifth card type 715 transforms any Earth symbol instances among matrix elements to Metal symbol instances.

FIG. 7c shows example cards 703 of a second deck of cards, for overcoming interactions in the first example implementation. The second deck of cards consists of y cards, where y depends on implementation. For example, y is 20, 30, or some other number. Each of the cards in the second deck is one of five distinct card types, as shown in FIG. 7c. A first card type 721 re-spins any Metal symbol instances among matrix elements, with each Metal symbol instance being removed and the corresponding reel being re-spun one time. A second card type 722 re-spins any Water symbol instances among matrix elements, with each Water symbol instance being removed and the corresponding reel being re-spun one time. A third card type 723 re-spins any Fire symbol instances among matrix elements, with each Fire symbol instance being removed and the corresponding reel being re-spun one time. A fourth card type 724 re-spins any Earth symbol instances among matrix elements, with each Earth symbol instance being removed and the corresponding reel being re-spun one time. Finally, a fifth card type 725 re-spins any Wood symbol instances among matrix elements, with each Wood symbol instance being removed and the corresponding reel being re-spun one time.

In FIGS. 7b and 7c, each card is associated with one operation (a re-spin or a transformation). Alternatively, a card can be added to perform both a re-spin and a transformation, or to otherwise combine multiple operations.

FIG. 7d shows an example UI 704 in the first example implementation. In FIG. 7d, a symbol matrix 740 includes a 3×3 configuration of matrix elements for independent reels. That is, each of the matrix element has a different, independent reel. The size of the symbol matrix can change, depending on implementation.

A player makes a wager and initiates the spinning of the nine reels. Three user-selectable action elements 751-753 are dealt. In FIG. 7d, the action elements 751-753 are cards from the first and second decks of cards. One card is dealt from the first deck (for generating interactions), and two cards are dealt from the second deck (for overcoming interactions). Of course, for a different spin, different cards can be dealt. The count of cards that are dealt, and the deck(s) from which the cards are dealt, can change depending on implementation.

In FIG. 7d, the nine reels have landed, such that the symbol matrix 740 contains nine landed matrix elements 741-749, including two Fire symbol instances 741, 748, three Earth symbol instances 742, 746, 747, two Water symbol instances 743, 744, and two Wood symbol instances 745, 749. Of course, for a different spin, different matrix elements can land. After the matrix elements 741-749 and user-selectable action elements 751-753 have landed, the player may choose up to three cards (action elements 751-753), in any order, to play. Thus, there are 16 different possible permutations to play the left (L), middle (M), and right (R) cards: LMR, LRM, MLR, MRL, RLM, RML, LM, LR, ML, MR, RL, RM, L, R, M, or none. The cards (action elements 751-753) are played in the order specified by the player to affect the matrix elements 741-749.

Finally, the outcome of the spin is determined for the resulting matrix elements (after the cards have been played) in the symbol matrix using scatter pays evaluation. FIG. 7e shows an example pay table 705 in the first example implementation. As shown, the top payout is “blackout” (nine-of-a-kind) for a 3×3 matrix. Alternatively, pay line evaluation can be used to determine the outcome, e.g., using 8 lines for a 3×3 matrix (three horizontal lines, three vertical lines, and two diagonal, crisscross lines), or ways evaluation can be used to determine the outcome.

2. Example Magic Battle Implementation.

FIGS. 8a-8c show different features of a second example implementation of an electronic gaming device, which uses sets of matrix elements for nine independent reels and uses two sets of user-selectable action elements, following a magic battle theme. Like the first example implementation, the second example implementation combines a slot reel mechanic for matrix elements in a symbol matrix with card playing aspects for the action elements.

FIG. 8a shows symbol instances and relationships 801 between five symbol types in the second example implementation. The five symbol types correspond to five types of magic: green, red, white, black, and blue. As in the first example implementation, there are two types of interactions: generating interactions and overcoming interactions. In the second example implementation, a generating interaction corresponds to a transformation of a matrix element from a first type to a second type different than the first type. An overcoming interaction corresponds to a re-spin of a matrix element.

A matrix element is a symbol instance that depicts one of the five types of magic. FIG. 8a shows example symbol instances for the five types of magic. Each matrix element is associated with a different, independent reel. The reel strip for a reel includes w symbol instances, where w depends on implementation. For example, w is 60, 80, or some other number. Each of the symbol instances in the reel strip is one of five distinct symbol types, as shown in FIG. 8a.

FIG. 8b shows interactions 802 for example cards of a first deck of cards in the second example implementation. The first deck of cards includes “spell” cards with associated transformation changes. The first deck of cards consists of x cards, where x depends on implementation. For example, x is 20, 30, or some other number. Each of the cards in the first deck is associated with one of five distinct transformations, as shown in FIG. 8b. For a transformation, any symbol instance of a first symbol type (among the matrix elements) is transformed to a symbol instance of a second symbol type.

FIG. 8c shows interactions 803 for example cards of a second deck of cards in the second example implementation. The second deck of cards includes “creature” cards with associated re-spin changes. The second deck of cards consists of y cards, where y depends on implementation. For example, y is 20, 30, or some other number. Each of the cards in the second deck is associated with one of five distinct re-spin changes, as shown in FIG. 8c. For a re-spin, any symbol instance of a given symbol type (among the matrix elements) is removed, and the corresponding reel is re-spun one time.

In FIGS. 8b and 8c, each card is associated with one operation (a re-spin or a transformation). Alternatively, a card can be added to perform both a re-spin and a transformation, or to otherwise combine multiple operations.

In the second example implementation, a symbol matrix (not shown) includes a 3×3 configuration of matrix elements for independent reels. That is, each of the matrix element has a different, independent reel. The size of the symbol matrix can change, depending on implementation. A player makes a wager and initiates the spinning of the nine reels. Three user-selectable action elements (cards) are dealt. One card is dealt from the first deck (for generating interactions), and two cards are dealt from the second deck (for overcoming interactions). The count of cards that are dealt, and the deck(s) from which the cards are dealt, can change depending on implementation. After the matrix elements and action elements (cards) have landed, the player may choose up to three cards, in any order, to play. There are 16 different possible permutations to play the three cards, as explained for the first example implementation. The cards (action elements) are played in the order specified by the player to affect the matrix elements. Finally, the outcome of the spin is determined for the resulting matrix elements (after the cards have been played) in the symbol matrix using scatter pays evaluation (or alternatively, pay line evaluation, ways evaluation, or another evaluation approach).

3. Example Knights Versus Dragons Implementation.

FIGS. 9a-9f show different features of a third example implementation of an electronic gaming device, which uses sets of matrix elements for nine independent reels and uses three sets of user-selectable action elements, following a “knights versus dragons” theme. Like the first and second example implementations, the third example implementation combines a slot reel mechanic for matrix elements in a symbol matrix with card playing aspects for the action elements.

There are six symbol types in the third example implementation: red dragon, blue dragon, green dragon, red knight, blue knight, and green knight. There are three types of interactions between elements: color transform (upgrade) interactions, shape transform (switch) interactions, and luck interactions. A color transform interaction corresponds to a transformation of a matrix element from a first color to a different, second color, which is associated with a higher payout than the first color. A shape transform interaction corresponds to a transformation of a matrix element from a knight to a dragon, or vice versa, without changing color. A luck interaction corresponds to a re-spin of a matrix element.

FIG. 9a shows example symbol instances 901 for the six symbol types. Each matrix element is associated with a different, independent reel. The reel strip for a reel includes w symbol instances, where w depends on implementation. For example, w is 60, 80, or some other number. Each of the symbol instances in the reel strip is one of six distinct symbol types, as shown in FIG. 9a.

FIG. 9b shows example cards 902 of a first deck of cards, for color transform (upgrade) interactions in the third example implementation. The first deck of cards consists of x cards, where x depends on implementation. For example, x is 20, 30, or some other number. Each of the cards in the first deck is one of six distinct card types, as shown in FIG. 9b. A first card type 911 transforms any Green Dragon symbol instances among matrix elements to Blue Dragon symbol instances. A second card type 912 transforms any Green Dragon symbol instances among matrix elements to Red Dragon symbol instances. A third card type 913 transforms any Blue Dragon symbol instances among matrix elements to Red Dragon symbol instances. A fourth card type 914 transforms any Green Knight symbol instances among matrix elements to Blue Knight symbol instances. A fifth card type 915 transforms any Green Knight symbol instances among matrix elements to Red Knight symbol instances. Finally, a sixth card type 916 transforms any Blue Knight symbol instances among matrix elements to Red Knight symbol instances.

FIG. 9c shows example cards 903 of a second deck of cards, for shape transform interactions in the third example implementation. The second deck of cards consists of y cards, where y depends on implementation. For example, y is 20, 30, or some other number. Each of the cards in the second deck is one of eight distinct card types, as shown in FIG. 9c. A first card type 921 transforms any Dragon symbol instances among matrix elements to Knight symbol instances of the same color (preserving color for any given matrix element). A second card type 922 transforms any Green Dragon symbol instances among matrix elements to Green Knight symbol instances. A third card type 923 transforms any Blue Dragon symbol instances among matrix elements to Blue Knight symbol instances. A fourth card type 914 transforms any Red Dragon symbol instances among matrix elements to Red Knight symbol instances. A fifth card type 925 transforms any Knight symbol instances among matrix elements to Dragon symbol instances of the same color (preserving color for any given matrix element). A sixth card type 926 transforms any Green Knight symbol instances among matrix elements to Green Dragon symbol instances. A seventh card type 927 transforms any Blue Knight symbol instances among matrix elements to Blue Dragon symbol instances. Finally, an eighth card type 928 transforms any Red Knight symbol instances among matrix elements to Red Dragon symbol instances.

FIG. 9d shows example cards 904 of a third deck of cards, for luck interactions in the third example implementation. The third deck of cards consists of z cards, where z depends on implementation. For example, z is 20, 30, or some other number. Each of the cards in the third deck is one of eight distinct card types, as shown in FIG. 9d. A first card type 931 re-spins any Dragon symbol instances among matrix elements, with each Dragon symbol instance being removed and the corresponding reel being re-spun one time. A second card type 932 re-spins any Green Dragon symbol instances among matrix elements, with each Green Dragon symbol instance being removed and the corresponding reel being re-spun one time. A third card type 933 re-spins any Blue Dragon symbol instances among matrix elements, with each Blue Dragon symbol instance being removed and the corresponding reel being re-spun one time. A fourth card type 934 re-spins any Red Dragon symbol instances among matrix elements, with each Red Dragon symbol instance being removed and the corresponding reel being re-spun one time. A fifth card type 935 re-spins any Knight symbol instances among matrix elements, with each Knight symbol instance being removed and the corresponding reel being re-spun one time. A sixth card type 936 re-spins any Green Knight symbol instances among matrix elements, with each Green Knight symbol instance being removed and the corresponding reel being re-spun one time. A seventh card type 937 re-spins any Blue Knight symbol instances among matrix elements, with each Blue Knight symbol instance being removed and the corresponding reel being re-spun one time. Finally, an eighth card type 938 re-spins any Red Knight symbol instances among matrix elements, with each Red Knight symbol instance being removed and the corresponding reel being re-spun one time.

In FIGS. 9b-9d, each card is associated with one operation (a re-spin or a transformation). Alternatively, a card can be added to perform both a re-spin and a transformation, or to otherwise combine multiple operations.

FIG. 9e shows an example UI 905 in the third example implementation. In FIG. 9e, a symbol matrix 940 includes a 3×3 configuration of matrix elements for independent reels. That is, each of the matrix element has a different, independent reel. The size of the symbol matrix can change, depending on implementation.

A player makes a wager and initiates the spinning of the nine reels by actuating a “Deal” button (not shown). Three user-selectable action elements are dealt. In FIG. 9e, the action elements are cards from the first, second, and third decks of cards. One card is dealt from the first deck (for upgrade interactions), one card is dealt from the second deck (for shape transform interactions), and one card is dealt from the third deck (for luck interactions). Of course, for a different spin, different cards can be dealt. The count of cards that are dealt, and the deck(s) from which the cards are dealt, can change depending on implementation.

In FIG. 9e, the nine reels have landed, such that the symbol matrix 940 contains nine landed matrix elements, including four Green Knight symbol instances, one Green Dragon symbol instance, one Blue Knight symbol instance, one Blue Dragon symbol instance, and two Red Knight symbol instances. Of course, for a different spin, different matrix elements can land.

After the matrix elements and user-selectable action elements have landed, the player may choose up to three cards (action elements), in any order, to play. For example, the player can queue cards to play by placing them in proximity to the symbol matrix 940—the card closest to the symbol matrix 940 is played first, followed by the next closest card, and so on. The player can click on a card to add it to the playlist. The player can click on the same card again to remove it from the playlist. After selecting the cards to play, the player can actuate the “End Turn” button 961 to play the selected cards, if any. The cards (action elements) are played in the order specified by the player to affect the matrix elements.

Finally, the outcome of the spin is determined for the resulting matrix elements (after the cards have been played) in the symbol matrix using scatter pays evaluation. FIG. 9f shows an example pay table 906 in the third example implementation. As shown, the top payout is “blackout” (nine-of-a-kind) for a 3×3 matrix. Alternatively, pay line evaluation can be used to determine the outcome, e.g., using 8 lines for a 3×3 matrix (three horizontal lines, three vertical lines, and two diagonal, crisscross lines), or ways evaluation or another evaluation approach can be used to determine the outcome. The UI 905 can include a button (not shown) that can be actuated to cause the pay table 906 to be displayed.

There are 16 different possible permutations to play the three cards (action elements). As shown in FIG. 9e, a hint window 965 can be displayed to show expected outcomes for possible permutations of playing the cards, and thereby provide hints about strategy for selecting cards to play for the current instance of the process. The player can actuate the “Hint” button 971 to cause the hint window to be displayed. In FIG. 9e, 1^{st}, 2^{nd} 3^{rd} refers to the card position from left to right. For example (2^{nd}, 1^{st}, 3^{rd}) indicates to play the middle card first, then the leftmost card, followed by rightmost card.

4. Other Implementations.

In other implementations, symbol instances represent different types or buildings, coins, gems, or other items that can be organized along upgrade paths. Instead of being presented as a two-dimensional graphic, a symbol matrix can be rendered as a 2.5 dimensional, isometric representation for a playfield.

E. Examples of Integration into Electronic Gaming Devices.

Innovations described herein can be implemented in a gaming server 102 and/or gaming device 104A, 104B, 104C, 104X, 200 described with reference to FIGS. 1 and 2. Thus, a gaming server 102 or gaming device 104A, 104B, 104C, 104X, 200 is an example of an electronic gaming device as described in section V.

For example, for the electronic gaming device, a game controller such as a game controller 202 described with reference to FIG. 2 can perform operations described herein. In some implementations, the game controller 202 performs backend operations as well as frontend UI operations. With respect to frontend UI operations, the game controller 202 can receive user input indicating a start to an instance of a process that uses one or more sets of matrix elements and one or more sets of user-selectable action elements. Further, the game controller 202 can control display of action elements and matrix elements for the instance of the process, receive user input indicating which of the action elements (if any) to apply, and control display of updated matrix elements. The game controller 202 can also control display of indicators an outcome of the instance of the process. With respect to backend operations, the game controller 202 can start an instance of a process that uses the set(s) of matrix elements and the set(s) of action elements, use RNG events to determine action elements and matrix elements for the instance of the process, apply selected action elements, and determine game outcomes.

Innovations described in section V can be implemented in a game processing pipeline that follows the example game processing architecture 300 described with reference to FIG. 3. As described with reference to FIG. 3, conversion engine 320 utilizes one or more lookup tables 322A-322N. In the context of the innovations described herein, for example, one or more of the lookup tables 322A-322N can be used to determine symbol positions at which to stop reel strips and/or to determine other results. In some variations, different lookup tables can be used, so as to adjust the likelihood of specific results depending on bet amount.

In general, the example game processing architecture 300 shown in FIG. 3 can be used to process game play instructions and generate outcomes. In some implementations, the game processing architecture 300 implements a game processing pipeline for a process (e.g., base reel game). The UI system 302 (e.g., the game play UI 304 of the UI system 302) receives user input that indicates a start to an instance of a process that uses one or more sets of matrix elements and one or more sets of user-selectable action elements. The backend system 314 starts an instance of the process. For the instance of the process, the UI system 302 (e.g., the game play UI 304) makes one or more RNG calls to the game processing backend system 314. In response, the backend system 314 performs various operations. Using a gaming RNG 318, the RNG engine 316 generates random numbers, which are passed to the conversion engine 320. The conversion engine 320, using the random number(s) and one or more of the lookup tables 322A-322N performs operations to determine action elements and matrix elements for the instance of the process. The UI system 302 displays the action elements and matrix elements. The UI system 302 receives user input indicating which of the action elements (if any) to apply. The UI system 302 makes one or more RNG calls and/or non-RNG calls to the game processing backend system 314 for any of the action elements that are applied. In response, the backend system 314 performs various operations to change the matrix elements, for example, using the user-input-driven engine 317 to map information from non-RNG calls to non-RNG outcomes, which are passed to the conversion engine 320, and/or using the RNG engine 316 to generate one or more random numbers, which are passed to the conversion engine 320. The conversion engine 320, using one or more of the random number(s) and one or more of the lookup tables 322A-322N, and also using the non-RNG calls, performs operations such as re-spin operations and transform operations. After determining the updated matrix elements, the backend system 314 returns the generated results to the game play UI 304 of the UI system 302, which can update display of graphical elements for the process. The backend system 314 also determines an outcome (e.g., calculating win conditions for scatter pays evaluation). The backend system 314 returns the generated results to the game play UI 304 of the UI system 302, which can display indicators of the outcome.

In general, the generated results returned by the backend system 314 can include game-related information (such as symbol positions at which to stop reel strips for the respective reels, outcomes) as well as animation effects not related to game parameters. Alternatively, the game play UI 304 can make one or more separate RNG calls to the backend system 314 to determine animation effects. In response, the backend system 314 can use the gaming RNG 318 and/or one or more of the non-gaming RNGs 319A-319N to generate random numbers, which the conversion engine 320 uses (with one or more of the lookup tables 322A-322N) to determine animation effects. The game play UI 304 (or bonus game play UI 308) can perform operations consistent with the animation effects, which are returned from the backend system 314.

F. Technical Advantages.

Approaches described herein address technical problems of allowing a player to select whether and when to apply user-selectable action elements in an electronic gaming device that uses one or more sets of matrix elements and one or more sets of user-selectable action elements. By combining skill-based decisions for the action elements with RNG-event-based aspects, this gameplay mechanic increases user engagement and interaction with the electronic gaming device. In particular, by providing a way to change matrix elements, the gameplay mechanic provides the player some control over an outcome. This can improve the usability of electronic gaming devices by enhancing the user experience for players, extending player time on the electronic gaming devices, and maintaining the interest of current players in the electronic gaming devices.

In terms of system architecture, innovative features described herein provide a way to account for skill-based decisions in an architecture that otherwise only permits RNG-event-based functionality (such as a traditional Class III architecture). For example, whereas a traditional processing pipeline calculates the positions at which RNG-event-based reels are going to be stopped in the future, a processing pipeline according to an improved architecture also accounts for positions at which a user causes one or more of the reels to be stopped, and accounts for a user causing one of the of the reels to be re-spun within the same instance of the process. This may require adjustments to how RNG-generated game outcomes are determined in the processing pipeline.

More generally, in terms of technical effects, innovative features of selecting between different ways of applying user-selectable action elements represent improvements in the technical area of electronic gaming software and provide new technology, in that they provide a simple and intuitive gameplay mechanic that provides the player some control over an outcome. At the same time, game play can be kept fair and consistent with regulations.

In some example implementations, adjustments can be made to how matrix elements are determined depending on which combination of user-selectable action elements has been determined for an instance of a process, so as to balance RTP between different instances of the process. In other example implementations, adjustments can be made to activation costs for user-selectable action elements depending on which combination of user-selectable action elements has been determined for an instance of a process, so as to balance RTP between different instances of the process. The skill-based selection mechanism permits a “user-driven” random outcome that complies with Class III gaming regulations and is comparable to a purely RNG-event-based random outcome. For such example implementations, a user-driven random outcome differs from skill-based games like video poker, where the skill-based decision-making has some impact on the RTP directly experienced by a player. In particular, in some example implementations, adjustments are made to attributes of RNG-event-based reels to compensate for different combinations of user-selectable action elements (which are associated with different levels of RTP), or adjustments are made to activation costs for user-selectable action elements to compensate for different combinations of user-selectable action elements (which are associated with different levels of RTP), so as to balance overall RTP. In terms of technical effects, innovative features of adjusting attributes of RNG-event-based reels represent improvements in the technical area of electronic gaming software and provide new technology, in that they provide a computationally effective way to achieve a designated level of RTP for an electronic gaming device that includes a skill-based mechanic and RNG-event-based mechanic. Furthermore, by managing lookup tables and/or other aspects of RNG events, or by adjusting activation costs for action elements, for an electronic gaming device that includes a skill-based mechanic and RNG-event-based mechanic, game play can be kept fair and consistent with regulations while also achieving the designated level of RTP.

These embodiments are thus not merely new game rules or new display patterns.

### VI. Other Features of Electronic Gaming Devices.

A typical electronic gaming device is a specially configured computer system, and not merely a general-purpose computer. For example, one difference between a typical electronic gaming device and common processor-based computer system is that the electronic gaming device is designed to be a state-based system. In a state-based system, the system stores and maintains its current state in non-volatile memory, which can be implemented using battery-backed RAM, flash memory, a solid-state drive, or other persistent memory. Different functions of a game (e.g., bet, play, result, points in the graphical presentation, etc.) may be defined as a state. When a game moves from one state to another, data regarding the game state is stored in a custom non-volatile memory subsystem. In some cases, the gaming device does not advance from a current state to a subsequent state until information that allows the current state to be reconstructed is stored. In the event of a power failure or other malfunction, the gaming device will return to its current state when the power is restored by recovering state information from non-volatile memory. The restored state may include metering information and graphical information that was displayed on the gaming device in the state prior to the malfunction. For instance, if a player was shown an award for a game of chance and, before the award could be provided to the player, the power failed, the gaming device, upon the restoration of power, would return to the state where the award is indicated. More generally, the gaming device records, in non-volatile memory, the values of game parameters assigned during play, such as variables determined by an RNG or internal counters. (A game parameter, in general, can be one or more variables whose values govern play at the gaming device and depend on a random selection process.) The value of a game parameter can be recorded periodically, in response to some event such as user input, or whenever the value of the game parameter changes. This way, the gaming device can recover its state in case of a power failure or “tilt” event, allowing the gaming device to reconstruct events that have taken place before the power failure or “tilt” event. This requirement affects the software and hardware design on a gaming device. Game history information regarding previous games played, such as an amount wagered, the outcome of the game and so forth, may also be stored in a non-volatile memory device.

In the context of the innovations described herein, for example, a game controller 202 can save information about mode for a base reel game, the reel strips in use, the reel area in use, user-selectable action elements that have been determined, and symbol positions at which to stop reel strips reels in non-volatile memory at various stages. The non-volatile memory can also store other state information, such as a current bet amount, an amount of credits remaining, and/or a win amount for a base reel game, bonus reel game and/or other feature. More generally, non-volatile memory can store state information such as positions of the respective reels, in addition to storing information that indicates the configuration of reel strips of the reels. After finishing a feature or a base reel game, the game controller 202 can store information in non-volatile memory that indicates an outcome (e.g., award amount) or status.

### VII. Innovative Features

Innovative features described herein include, but are not limited to, the following.

| | Feature |
|---|---|
| A1 | A method of integrating a skill-based selection mechanism and a random number |
| | generator (“RNG”)-event-based mechanism in an electronic gaming device, the method |
| | comprising: |
| | starting an instance of a process that uses one or more sets of matrix elements and |
| | one or more sets of user-selectable action elements; |
| | determining, based at least in part on one or more first RNG events, one or more |
| | user-selectable action elements from the one or more sets of user-selectable action |
| | elements; |
| | determining, based at least in part on second RNG events, matrix elements from |
| | the one or more sets of matrix elements; |
| | selectively changing at least one of the matrix elements according to those of the |
| | one or more user-selectable action elements, if any, that have been applied by a user; |
| | and determining, based at least in part on the matrix elements after the selectively |
| | changing, an outcome of the instance of the process. |
| A2 | The method of A1, wherein the determining the one or more user-selectable action |
| | elements includes, for each of the one or more user-selectable action elements: |
| | generating a random number; and determining, based at least in part on the random |
| | number, the user-selectable action element from a given set of the one or more sets |
| | of user-selectable action elements. |
| A3 | The method of A2, wherein the determining the user-selectable action element |
| | from the given set includes determining an identifier using a lookup table, the lookup |
| | table including entries that indicate identifiers for different user-selectable action |
| | elements in the given set. |
| A4 | The method of A1, further comprising, after the determining the one or more user- |
| | selectable action elements, sending information that indicates the one or more user- |
| | selectable action elements. |
| A5 | The method of A1, wherein the determining the one or more user-selectable action |
| | elements precedes the determining the matrix elements. |
| A6 | The method of A5, wherein different possible combinations of user-selectable |
| | action elements of the one or more sets of user-selectable action elements are not |
| | balanced with respect to return to player. |
| A7 | The method of A5, further comprising, before the determining the matrix |
| | elements, adjusting how to perform the determining the matrix elements based on |
| | the one or more user-selectable action elements that have been determined. |
| A8 | The method of A7, wherein the adjusting how to perform the determining the |
| | matrix elements includes, for a given set of the one or more sets of matrix elements, |
| | adjusting one or more of: (a) a reel strip, (b) a lookup table associated with the |
| | given set, and (c) how dynamic symbols are resolved for the reel strip, to balance |
| | return to player in view of the one or more user-selectable action elements |
| | that have been determined. |
| A9 | The method of A1, wherein the determining the one or more user-selectable action |
| | elements follows the determining the matrix elements. |
| A10 | The method of A9, wherein different possible combinations of user-selectable |
| | action elements of the one or more sets of user-selectable action elements are |
| | balanced with respect to return to player. |
| A11 | The method of A1, wherein at least some different user-selectable action elements |
| | in the one or more sets of user-selectable action elements have different activation |
| | costs, the different activation costs having been assigned so that different |
| | possible combinations of user-selectable action elements of the one or more |
| | sets of user-selectable action elements are balanced with respect to return to player. |
| A12 | The method of A11, wherein the different activation costs are different amounts of |
| | credits. |
| A13 | The method of A11, further comprising: |
| | for the one or more sets of user-selectable action elements, determining activation |
| | costs for respective user-selectable action elements of the one or more sets of user- |
| | selectable action elements. |
| A14 | The method of A1, wherein the determining the matrix elements includes, for each |
| | of the matrix elements: |
| | generating a random number; and |
| | determining, based at least in part on the random number, the matrix element from |
| | a given set of the one or more sets of matrix elements. |
| A15 | The method of A14, wherein the determining the matrix element from the given |
| | set includes determining a stop position, for a reel strip of a reel associated with the |
| | matrix element, using a lookup table, the lookup table including entries that indicate |
| | different stop positions of the reel strip for the reel. |
| A16 | The method of A1, further comprising, after the determining the matrix elements, |
| | sending information that indicates the matrix elements. |
| A17 | The method of A1, wherein the selectively changing includes, for a given matrix |
| | element of the matrix elements, determining, based at least in part on another |
| | RNG event, a new matrix element to replace the given matrix element. |
| A18 | The method of A1, wherein the selectively changing includes, for a given matrix |
| | element of the matrix elements, converting the given matrix element from a first |
| | type to a second type different than the first type. |
| A19 | The method of A1, wherein the selectively changing includes, for each of the one |
| | or more user-selectable action elements that has been applied by the user: |
| | determining which of the matrix elements, if any, are affected by the user- |
| | selectable action element; and |
| | making changes to those of the matrix elements, if any, that are affected by the |
| | user-selectable action element. |
| A20 | The method of A19, wherein the changes include one or more of: (a) re-spinning |
| | those of the matrix elements that are affected by the user-selectable action element; |
| | and (b) converting those of the matrix elements that are affected by the user-selectable |
| | action element from a first type to a second type different than the first type. |
| A21 | The method of A20, wherein the changes further include, for a given set of the one |
| | or more sets of matrix elements, one or more of: (c) changing a reel strip; (d) adding |
| | one or more wild symbols to the reel strip; and (e) changing how many matrix |
| | elements are displayed. |
| A22 | The method of A19, further comprising sending information that indicates any |
| | matrix elements that have been changed by the user-selectable action element. |
| A23 | The method of A1, further comprising: |
| | evaluating possible permutations for applying the one or more user-selectable |
| | action elements; and |
| | sending information indicating, for each of the evaluated permutations, an |
| | expected outcome for that permutation. |
| A24 | The method of A1, further comprising: |
| | sending information indicating, for each of the one or more user-selectable action |
| | elements, an effect of applying the user-selectable action element and an activation cost |
| | for the user-selectable action element. |
| A25 | The method of A1, further comprising: |
| | setting a count of the one or more user-selectable action elements based on bet |
| | level, bet denomination, or another factor. |
| B1 | A method of integrating a skill-based selection mechanism and a random number |
| | generator (“RNG”)-event-based mechanism in an electronic gaming device, the method |
| | comprising: |
| | receiving, from a user, user input that indicates to start an instance of a process |
| | that uses one or more sets of matrix elements and one or more sets of user-selectable |
| | action elements; |
| | displaying one or more user-selectable action elements, the one or more user- |
| | selectable action elements having been determined from the one or more sets of user- |
| | selectable action elements based at least in part on one or more first RNG events; |
| | displaying matrix elements, the matrix elements having been determined from the |
| | one or more sets of matrix elements based at least in part on second RNG events; |
| | receiving, from the user, user input that indicates how, if at all, to apply the one or |
| | more user-selectable action elements; |
| | selectively updating display of at least one of the matrix elements, the at least one |
| | of the matrix elements having been selectively changed according to any of the one or |
| | more user-selectable action elements that has been applied; and |
| | outputting an indicator of an outcome of the instance of the process, the outcome |
| | being based at least in part on the matrix elements after the selective changes. |
| B2 | The method of B1, wherein the user input that indicates to start the instance of the |
| | process is a button press of a physical button, touchscreen button, or other virtual |
| | button. |
| B3 | The method of B1, further comprising, after the receiving the user input that |
| | indicates to start the instance of the process: |
| | displaying spinning elements in positions for the matrix elements. |
| B4 | The method of B1, wherein the matrix elements are organized in a symbol matrix, |
| | and wherein the one or more user-selectable action elements are displayed adjacent the |
| | symbol matrix. |
| B5 | The method of B1, wherein the displaying the one or more user-selectable action |
| | elements precedes the displaying the matrix elements. |
| B6 | The method of B1, wherein the displaying the one or more user-selectable action |
| | elements follows the displaying the matrix elements. |
| B7 | The method of B1, wherein the user input that indicates how, if at all, to apply the |
| | one or more user-selectable action elements indicates: |
| | for each of the one or more user-selectable action elements, whether or not to |
| | apply that user-selectable action element; and/or |
| | an order to apply the one or more user-selectable action elements, if at all. |
| B8 | The method of B1, further comprising, after the receiving the user input that |
| | indicates how, if at all, to apply the one or more user-selectable action elements |
| | includes: sending information that indicates how, if at all, to apply the one or |
| | more user-selectable action elements. |
| B9 | The method of B1, further comprising, displaying a timer, the timer depicting an |
| | amount of time to provide the user input that indicates how, if at all, to apply the |
| | one or more user-selectable action elements. |
| B10 | The method of B1, wherein the selectively updating the display of at least one of |
| | the matrix elements includes, for each of the one or more user-selectable action |
| | elements that has been applied by the user: |
| | updating the display of those of the matrix elements, if any, that are affected by |
| | the user-selectable action element. |
| B11 | The method of B1, further comprising: |
| | receiving information indicating, for each of multiple possible permutations for |
| | applying the one or more user-selectable action elements, an expected outcome |
| | for that permutation; and displaying the expected outcomes for the multiple |
| | possible permutations, respectively. |
| B12 | The method of B1, further comprising: |
| | receiving information indicating, for each of the one or more user-selectable |
| | action elements, an effect of applying the user-selectable action element and an |
| | activation cost for the user-selectable action element; and |
| | displaying the information indicating, for each of the one or more user-selectable |
| | action elements, the effect of applying the user-selectable action element and the |
| | activation cost for the user-selectable action element. |
| B13 | The method of B1, wherein the indicator of the outcome of the instance of the |
| | process is a graphical indicator for a win amount. |
| AB1 | The method of any one of A1-A25 and B1-B13, wherein the matrix elements are |
| | symbol instances on reel strips of reels, and wherein each of the one or more sets of |
| | matrix elements is associated with a different, independent reel. |
| AB2 | The method of any one of A1-A25 and B1-B13, wherein the one or more user- |
| | selectable action elements are one or more cards, and wherein each of the one or more |
| | sets of user-selectable action elements is a different deck of cards. |
| AB3 | The method of any one of A1-A25 and B1-B13, wherein the matrix elements are |
| | arranged in a p × q configuration, with p indicating a count of matrix elements |
| | horizontally across the p × q configuration, with q indicating a count of matrix elements |
| | vertically across the p × q configuration, and with each of the matrix elements being |
| | associated with a different, independent reel for one of the one or more sets of matrix |
| | elements, and wherein the one or more user-selectable action elements are arranged |
| | adjacent the matrix elements in the p × q configuration. |
| AB4 | The method of any one of A1-A25 and B 1-B 13, wherein: |
| | all of the one or more of the user-selectable action elements are applied by the |
| | user; |
| | at least one but less than all of the one or more of the user-selectable action |
| | elements are applied by the user; or none of the one or more of the user-selectable |
| | action elements are applied by the user. |
| AB5 | The method of any one of A1-A25 and B1-B13, wherein the determining the |
| | outcome of the instance of the process: |
| | uses scatter pay evaluation based on one or more threshold counts of matrix |
| | elements; |
| | uses pay line evaluation for one or more pay lines across a matrix containing the |
| | matrix elements; or |
| | uses ways evaluation across a matrix that contains the matrix elements, depending |
| | on win conditions for combination of symbol instances along possible paths through |
| | active symbol display positions of the matrix, wherein, for each of the possible paths |
| | through the active symbol display positions of the matrix, the possible path uses |
| | one of the symbol instances per column and crosses the matrix from one side of the |
| | matrix to an opposite side of the matrix. |
| AB6 | A computer system comprising one or more processors and memory readable by |
| | the one or more processors, the memory having stored thereon computer-executable |
| | instructions for causing the one or more processors, when programmed thereby, to |
| | perform operations for the method of any of A1-A25, B1-B13, and AB1-AB5. |
| AB7 | One or more non-transitory computer-readable media having stored thereon |
| | computer-executable instructions for causing one or more processors, when |
| | programmed thereby, to perform operations for the method of any of A1-A25, |
| | B1-B13, and AB1-AB5. |

### VIII. Alternatives and Variations.

Numerous embodiments are described in this disclosure, and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments. Headings of sections provided in this disclosure are for convenience only, and are not to be taken as limiting the disclosure in any way.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise.

For the sake of presentation, the detailed description uses terms like “determine” and “select” to describe computer operations in a computer system. These terms denote operations performed by a computer, and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to insure privacy and prevent fraud in any of a variety of ways well known in the art.

It will be readily apparent that the various methods and algorithms described herein may be implemented by, e.g., appropriately programmed general-purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

While the invention has been described with respect to the figures, it will be appreciated that many modifications and changes may be made by those skilled in the art without departing from the spirit of the invention. Any variation and derivation from the above description and figures are included in the scope of the present invention as defined by the claims. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

I claim:

1. A computer system comprising one or more processors and memory readable by the one or more processors, the memory having stored thereon computer-executable instructions for causing the one or more processors, when programmed thereby, to perform operations to integrate a skill-based selection mechanism and a random number generator (“RNG”)-event-based mechanism in an electronic gaming device, the operations comprising:
starting an instance of a process that uses one or more sets of matrix elements and one or more sets of user-selectable action elements;
determining, based at least in part on one or more first RNG events, one or more user-selectable action elements from the one or more sets of user-selectable action elements;
determining, based at least in part on second RNG events, matrix elements from the one or more sets of matrix elements;
selectively changing at least one of the matrix elements according to those of the one or more user-selectable action elements, if any, that have been applied by a user; and
determining, based at least in part on the matrix elements after the selectively changing, an outcome of the instance of the process.

2. The computer system of claim 1, wherein the determining the one or more user-selectable action elements includes, for each of the one or more user-selectable action elements:
generating a random number; and
determining, based at least in part on the random number, the user-selectable action element from a given set of the one or more sets of user-selectable action elements.

3. The computer system of claim 1, wherein the determining the one or more user-selectable action elements precedes the determining the matrix elements, and wherein different possible combinations of user-selectable action elements of the one or more sets of user-selectable action elements are not balanced with respect to return to player.

4. The computer system of claim 1, wherein the determining the one or more user-selectable action elements precedes the determining the matrix elements, the operations further comprising:
before the determining the matrix elements, adjusting how to perform the determining the matrix elements based on the one or more user-selectable action elements that have been determined, wherein the adjusting how to perform the determining the matrix elements includes, for a given set of the one or more sets of matrix elements, adjusting one or more of: (a) a reel strip, (b) a lookup table associated with the given set, and (c) how dynamic symbols are resolved for the reel strip, to balance return to player in view of the one or more user-selectable action elements that have been determined.

5. The computer system of claim 1, wherein the determining the one or more user-selectable action elements follows the determining the matrix elements, and wherein different possible combinations of user-selectable action elements of the one or more sets of user-selectable action elements are balanced with respect to return to player.

6. The computer system of claim 1, wherein at least some different user-selectable action elements in the one or more sets of user-selectable action elements have different activation costs, the different activation costs having been assigned so that different possible combinations of user-selectable action elements of the one or more sets of user-selectable action elements are balanced with respect to return to player.

7. The computer system of claim 6, wherein the operations further comprise:
for the one or more sets of user-selectable action elements, determining activation costs for respective user-selectable action elements of the one or more sets of user-selectable action elements.

8. The computer system of claim 1, wherein the selectively changing includes, for a given matrix element of the matrix elements:
determining, based at least in part on another RNG event, a new matrix element to replace the given matrix element; or
converting the given matrix element from a first type to a second type different than the first type.

9. The computer system of claim 1, wherein the selectively changing includes, for each of the one or more user-selectable action elements that has been applied by the user:
determining which of the matrix elements, if any, are affected by the user-selectable action element; and
making changes to those of the matrix elements, if any, that are affected by the user-selectable action element.

10. The computer system of claim 1, further comprising:
evaluating possible permutations for applying the one or more user-selectable action elements; and
sending information indicating, for each of the evaluated permutations, an expected outcome for that permutation.

11. The method of claim 1, further comprising:
setting a count of the one or more user-selectable action elements based on bet level, bet denomination, or another factor.

12. The computer system of claim 1, wherein the matrix elements are symbol instances on reel strips of reels, wherein each of the one or more sets of matrix elements is associated with a different, independent reel, wherein the one or more user-selectable action elements are one or more cards, and wherein each of the one or more sets of user-selectable action elements is a different deck of cards.

13. A method of integrating a skill-based selection mechanism and a random number generator (“RNG”)-event-based mechanism in an electronic gaming device, the method comprising:
starting an instance of a process that uses one or more sets of symbol instances, on reel strips of reels, and one or more sets of user-selectable cards, wherein at least some different user-selectable cards in the one or more sets of user-selectable cards have different activation costs, the different activation costs having been assigned so that different possible combinations of user-selectable cards of the one or more sets of user-selectable cards are balanced with respect to return to player;
determining, based at least in part on one or more first RNG events, one or more user-selectable cards from the one or more sets of user-selectable cards;
determining, based at least in part on second RNG events, symbol instances from the one or more sets of symbol instances;
selectively changing at least one of the symbol instances according to those of the one or more user-selectable cards, if any, that have been applied by a user; and
determining, based at least in part on the symbol instances after the selectively changing, an outcome of the instance of the process.

14. One or more non-transitory computer-readable media having stored thereon computer-executable instructions for causing one or more processors, when programmed thereby, to perform operations to integrate a skill-based selection mechanism and a random number generator (“RNG”)-event-based mechanism in an electronic gaming device, the operations comprising:
receiving, from a user, user input that indicates to start an instance of a process that uses one or more sets of matrix elements and one or more sets of user-selectable action elements;
displaying one or more user-selectable action elements, the one or more user-selectable action elements having been determined from the one or more sets of user-selectable action elements based at least in part on one or more first RNG events;
displaying matrix elements, the matrix elements having been determined from the one or more sets of matrix elements based at least in part on second RNG events;
receiving, from the user, user input that indicates how, if at all, to apply the one or more user-selectable action elements;
selectively updating display of at least one of the matrix elements, the at least one of the matrix elements having been selectively changed according to any of the one or more user-selectable action elements that has been applied; and
outputting an indicator of an outcome of the instance of the process, the outcome being based at least in part on the matrix elements after the selective changes.

15. The one or more non-transitory computer-readable media of claim 14, wherein the matrix elements are organized in a symbol matrix, wherein the one or more user-selectable action elements are displayed adjacent the symbol matrix, and wherein the operations further comprise, after the receiving the user input that indicates to start the instance of the process:
displaying spinning elements in positions for the matrix elements.

16. The one or more non-transitory computer-readable media of claim 14, wherein the displaying the one or more user-selectable action elements precedes the displaying the matrix elements or follows the displaying the matrix elements.

17. The one or more non-transitory computer-readable media of claim 14, wherein the user input that indicates how, if at all, to apply the one or more user-selectable action elements indicates:
for each of the one or more user-selectable action elements, whether or not to apply that user-selectable action element; and/or
an order to apply the one or more user-selectable action elements, if at all.

18. The one or more non-transitory computer-readable media of claim 14, wherein the operations further comprise:
displaying a timer, the timer depicting an amount of time to provide the user input that indicates how, if at all, to apply the one or more user-selectable action elements.

19. The one or more non-transitory computer-readable media of claim 14, wherein the selectively updating the display of at least one of the matrix elements includes, for each of the one or more user-selectable action elements that has been applied by the user:
updating the display of those of the matrix elements, if any, that are affected by the user-selectable action element.

20. The one or more non-transitory computer-readable media of claim 14, wherein the operations further comprise:
(a) receiving information indicating, for each of multiple possible permutations for applying the one or more user-selectable action elements, an expected outcome for that permutation, and displaying the expected outcomes for the multiple possible permutations, respectively; or
(b) receiving information indicating, for each of the one or more user-selectable action elements, an effect of applying the user-selectable action element and an activation cost for the user-selectable action element, and displaying the information indicating, for each of the one or more user-selectable action elements, the effect of applying the user-selectable action element and the activation cost for the user-selectable action element.
